(19) United States
(12) Patent Application Publication
(10) Pub. No.: US 2026/0156492 A1
(43) Pub. Date: Jun. 4, 2026

(54) FIELD OF VIEW INFORMATION FOR SENSING

(71) Applicant: Lenovo (United States) Inc., Morrisville, NC (US)

(72) Inventors: Robin Rajan Thomas, Bad Nauheim (DE); Seyedomid Taghizadeh Motlagh, Oberursel (DE)

(73) Assignee: Lenovo (United States) Inc., Morrisville, NC (US)

(21) Appl. No.: 18/965,841

(22) Filed: Dec. 2, 2024

(51) Int. Cl. H04W 24/02; H04B 7/06; H04W 24/10

(52) U.S. Cl. CPC H04W 24/02; H04B 7/06952; H04W 24/10

(57) ABSTRACT

Various aspects of the present disclosure relate to field of view information for sensing. An apparatus (e.g., user equipment (UE), network equipment (NE)) receives configuration information including one or more parameters associated with identifying a field of view, and receives a reference signal based at least in part on a receive antenna configuration, where the receive antenna configuration is based at least in part on the configuration information. The apparatus performs at least one sensing measurement based at least in part on the reference signal.

### TECHNICAL FIELD

The present disclosure relates to wireless communications, and more specifically to sensing in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive configuration information including one or more parameters associated with identifying a field of view; receive a reference signal based at least in part on a receive antenna configuration, where the receive antenna configuration is based at least in part on the configuration information; and perform at least one sensing measurement based at least in part on the reference signal.

A processor (e.g., a standalone processor chipset, or a component of a UE) for wireless communication is described. The processor may be configured to, capable of, or operable to perform one or more operations as described herein. For example, the processor may be configured to, capable of, or operable to receive configuration information including one or more parameters associated with identifying a field of view; receive a reference signal based at least in part on a receive antenna configuration, where the receive antenna configuration is based at least in part on the configuration information; and perform at least one sensing measurement based at least in part on the reference signal.

A method performed or performable by a UE for wireless communication is described. The method may include receiving configuration information including one or more parameters associated with identifying a field of view; receiving a reference signal based at least in part on a receive antenna configuration, where the receive antenna configuration is based at least in part on the configuration information; and performing at least one sensing measurement based at least in part on the reference signal.

In some implementations of the UE, the processor, and the method described herein, the configuration information includes an expected target field of view and uncertainty information associated with the expected target field of view.

In some implementations of the UE, the processor, and the method described herein, the configuration information indicates scan limit information including one or more of: at least one minimum scan limit, at least one maximum scan limit, at least one minimum beam sweep limit, at least one maximum beam sweep limit, or at least one beam sweep direction.

In some implementations of the UE, the processor, and the method described herein, the configuration information further includes field of view information elements, where the field of view information elements includes one or more of: an uptilt indication, a downtilt indication, an expected angular resolution, an expected angular uncertainty, an expected bistatic angular information, an expected beam power, or an expected beamwidth.

In some implementations of the UE, the processor, and the method described herein, the configuration information further includes local coordinate system (LCS) to global coordinate system (GCS) translation parameters including one or more of a bearing angle, a downtilt angle, or a slant angle.

In some implementations of the UE, the processor, and the method described herein, the configuration information further includes one or more scan mode indications, and where each of the one or more scan mode indications is based at least in part on a respective type of scan mode.

In some implementations of the UE, the processor, and the method described herein, the configuration information includes one or more of field of view information, scan limit information, or scan mode information; the one or more of the field of view information, the scan limit information, or the scan mode information is associated with validity criteria; and the validity criteria includes one or more of a temporal validity criterion or an area validity criterion.

In some implementations of the UE, the processor, and the method described herein, the UE, the processor, and the method may further be configured to, capable of, operable to, performed to, or performable to one or more of: request one or more of updated field of view information, updated scan limit information, or updated scan mode information; or receive one or more of updated field of view information, updated scan limit information, or updated scan mode information.

In some implementations of the UE, the processor, and the method described herein, the UE, the processor, and the method may further be configured to, capable of, operable to, performed to, or performable to transmit a reference signal based at least in part on a transmit antenna configuration, where the transmit antenna configuration is based at least in part on the configuration information.

An NE (e.g., a base station) for wireless communication is described. The NE may be configured to, capable of, or operable to perform one or more operations as described herein. For example, the NE may be configured to, capable of, or operable to receive configuration information including one or more parameters associated with identifying a field of view; receive a reference signal based at least in part on a receive antenna configuration, where the receive antenna configuration is based at least in part on the configuration information; and perform at least one sensing measurement based at least in part on the reference signal.

A processor (e.g., a standalone processor chipset, or a component of a NE) for wireless communication is described. The processor may be configured to, capable of, or operable to perform one or more operations as described herein. For example, the processor may be configured to, capable of, or operable to receive configuration information including one or more parameters associated with identifying a field of view; receive a reference signal based at least in part on a receive antenna configuration, where the receive antenna configuration is based at least in part on the configuration information; and perform at least one sensing measurement based at least in part on the reference signal.

A method performed or performable by an NE (e.g., a base station) for wireless communication is described. The method may include receiving configuration information including one or more parameters associated with identifying a field of view; receiving a reference signal based at least in part on a receive antenna configuration, where the receive antenna configuration is based at least in part on the configuration information; and performing at least one sensing measurement based at least in part on the reference signal.

In some implementations of the NE, the processor, and the method described herein, the configuration information includes an expected target field of view and uncertainty information associated with the expected target field of view.

In some implementations of the NE, the processor, and the method described herein, the configuration information indicates scan limit information including one or more of: at least one minimum scan limit, at least one maximum scan limit, at least one minimum beam sweep limit, at least one maximum beam sweep limit, or at least one beam sweep direction.

In some implementations of the NE, the processor, and the method described herein, the configuration information further includes field of view information elements, where the field of view information elements includes one or more of: an uptilt indication, a downtilt indication, an expected angular resolution, an expected angular uncertainty, an expected bistatic angular information, an expected beam power, or an expected beamwidth.

In some implementations of the NE, the processor, and the method described herein, the configuration information further includes LCS to GCS translation parameters including one or more of a bearing angle, a downtilt angle, or a slant angle.

In some implementations of the NE, the processor, and the method described herein, the configuration information further includes one or more scan mode indications, and where each of the one or more scan mode indications is based at least in part on a respective type of scan mode.

In some implementations of the NE, the processor, and the method described herein, the configuration information includes one or more of field of view information, scan limit information, or scan mode information; the one or more of the field of view information, the scan limit information, or the scan mode information is associated with validity criteria; and the validity criteria includes one or more of a temporal validity criterion or an area validity criterion.

In some implementations of the NE, the processor, and the method described herein, the NE, the processor, and the method may further be configured to, capable of, operable to, performed to, or performable to one or more of: request one or more of updated field of view information, updated scan limit information, or updated scan mode information; or receive one or more of updated field of view information, updated scan limit information, or updated scan mode information.

An NE (e.g., a base station) for wireless communication is described. The NE may be configured to, capable of, or operable to perform one or more operations as described herein. For example, the NE may be configured to, capable of, or operable to transmit configuration information including one or more parameters associated with identifying a field of view, where the configuration information includes an expected target field of view and uncertainty information associated with the expected target field of view.

A processor (e.g., a standalone processor chipset, or a component of a NE) for wireless communication is described. The processor may be configured to, capable of, or operable to perform one or more operations as described herein. For example, the processor may be configured to, capable of, or operable to transmit configuration information including one or more parameters associated with identifying a field of view, where the configuration information includes an expected target field of view and uncertainty information associated with the expected target field of view.

A method performed or performable by an NE (e.g., a base station) for wireless communication is described. The method may include transmitting configuration information including one or more parameters associated with identifying a field of view, where the configuration information includes an expected target field of view and uncertainty information associated with the expected target field of view.

In some implementations of the NE, the processor, and the method described herein, the NE, the processor, and the method may further be configured to, capable of, operable to, performed to, or performable to transmit a reference signal based at least in part on a transmit antenna configuration, where the transmit antenna configuration is based at least in part on the configuration information.

In some implementations of the NE, the processor, and the method described herein, the NE includes a radio access network (RAN) entity or a core network (CN) entity.

### BRIEF DESCRIPTION OF THE DRAWINGS

FIG. 1 illustrates an example of a wireless communications system in accordance with aspects of the present disclosure.

FIG. 2 illustrates an example wireless communications system for radio sensing that supports configuration for radio sensing in accordance with aspects of the present disclosure.

FIG. 3 illustrates an example wireless communications system for radio sensing that support configuration for radio sensing in accordance with aspects of the present disclosure.

FIG. 4 illustrates an example scenario for a tight coupling integrated sensing and communication (ISAC) network architecture.

FIG. 5 illustrates an example scenario for a tight coupling ISAC network architecture.

FIG. 6 illustrates an example where a sensing function (SF) is collocated with the location management function (LMF).

FIG. 7 illustrates an example for loose coupling ISAC network architecture.

FIG. 8 illustrates an example for transmit and echo pulse time domain representation.

FIG. 9 illustrates an example assistance data transfer operations for a positioning procedure.

FIG. 10 illustrates example scenarios in accordance with aspects of the present disclosure.

FIG. 11 illustrates a signaling diagram in accordance with aspects of the present disclosure.

FIG. 12 illustrates a signaling diagram in accordance with aspects of the present disclosure.

FIG. 13 illustrates an example of a UE in accordance with aspects of the present disclosure.

FIG. 14 illustrates an example of a processor in accordance with aspects of the present disclosure.

FIG. 15 illustrates an example of an NE in accordance with aspects of the present disclosure.

FIG. 16 illustrates a flowchart of a method in accordance with aspects of the present disclosure.

FIG. 17 illustrates a flowchart of a method in accordance with aspects of the present disclosure.

FIG. 18 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In addition to wireless communication, time-frequency resources may be used for sensing, such as for object (e.g., human) detection, weather monitoring, automated guided vehicle (AGV) monitoring and tracking, automotive sensing, utilization of sensing and positioning information, etc. To enable accurate sensing, performance parameters can be specified, e.g., accuracy, resolution, latency, etc. The performance parameters, for instance, may be based on different sensing characteristics (e.g., radar cross section (RCS)) of one or multiple sensing target objects and/or an environment to be sensed in a target sensing service area. To support sensing, wireless communication networks can implement scenarios involving different RAN entities and UEs as sensing-related nodes. Some sensing and positioning frameworks enable a LMF to provide a RAN node, transmission-reception point (TRP), and/or NE with assistance information including an expected uplink (UL)-angle of arrival (AoA) and associated uncertainty range. In cases of sidelink (SL) positioning, a server UE can provide a target UE with assistance information relating to the expected SL-AoA and associated uncertainty range, where the AoAs can be expressed in terms of azimuth, zenith, or elevation.

In some sensing scenarios including a NE (e.g., base stations, TRPs, gNBs) or a UE acting as a sensing receive entity (sensing Rx entity) (e.g., TRP-TRP for TRP-TRP bistatic) involve a sensing system that includes information regarding a direction of a sensing target. Such information can mitigate issues in terms of performing beam sweeping and/or sensing scans in target areas which are not in an area of a target or detection/sensing area. Some wireless sensing systems, however, lack a mechanism by which a sensing transmit entity (sensing Tx entity) and sensing Rx entity can transmit and receive reflected signals of one or more sensing targets. In some scenarios a challenge is to avoid unnecessary beam sweeping/sensing scans of areas of no interest, which can consume additional power from a network perspective. The sensing Tx entity and the sensing Rx entity may communicate using an antenna reference information. The antenna reference information of both the sensing Tx entity and sensing Rx entity are to be well aligned depending on sensing result use cases, e.g., detection tasks, tracking tasks, target classification tasks. Another challenge in wireless sensing systems is to efficiently exchange the correct GCS and LCS information parameters related to the target to be sensed or sensing target area considering the geometrical positions of the sensing Tx entity, sensing target, and sensing Rx entity.

Aspects of the present disclosure are described in the context of a wireless communications system, and include implementations that provide field of view, beam sweep, and scan limit information. This information can assist a sensing Rx entity in adapting and/or modifying its sensing Rx characteristic(s) according to a sensing area and/or estimated target location(s). In some implementations, various scan modes are defined that enable beam sweeping according to different 2-dimensional (2D) and/or 3-dimensional (3D) patterns. The described scan modes, for example, can be based on sensing target characteristics including mobility, as well as sensing parameters. In at least some implementations, different entities (e.g., a sensing configuration entity, sensing Tx entity) may configure the field of view, beam sweep, scan limit, and scan modes for different sensing Rx entities, e.g., sensing Rx entities implemented as a RAN entity and/or a UE.

By performing the described techniques, devices in a wireless communications system can implement more accurate and adaptable wireless sensing, such as for sensing objects in different environments and based on different environmental attributes. By implementing more accurate and adaptable wireless sensing, power usage in wireless communications systems can be reduced, such as by reducing unnecessary sensing-related scanning.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

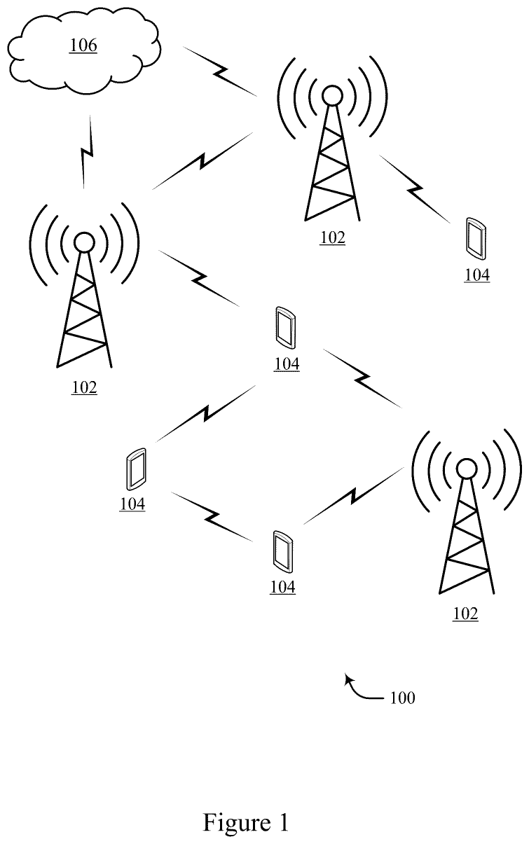

FIG. 1 illustrates an example of a wireless communications system 100 in accordance with aspects of the present disclosure. The wireless communications system 100 may include one or more NEs 102, one or more UEs 104, and a CN 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. Reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHz), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives configuration information including one or more parameters associated with identifying a field of view, and receives a reference signal based at least in part on a receive antenna configuration, where the receive antenna configuration is based at least in part on the configuration information. The UE 104 performs at least one sensing measurement based at least in part on the reference signal.

An NE 102 (e.g., a base station, gNB) receives configuration information including one or more parameters associated with identifying a field of view, and receives a reference signal based at least in part on a receive antenna configuration, where the receive antenna configuration is based at least in part on the configuration information. The NE 102 performs at least one sensing measurement based at least in part on the reference signal.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Example scenarios are discussed below for network-based and UE-based radio sensing operations. The scenarios include radio sensing where the network configures the participating sensing entities (e.g., network and UE nodes acting as sensing Tx entities, network and UE nodes acting as sensing Rx entities) as well as the configuration of sensing signals, measurements procedures, and reporting procedures from the participating sensing entities. A functional allocation between the network and the UE nodes for a specific sensing task (e.g., task of detecting presence of a pedestrian in a road) may take various forms, such as based on the availability of sensing-capable devices and the parameters of the specific sensing task.

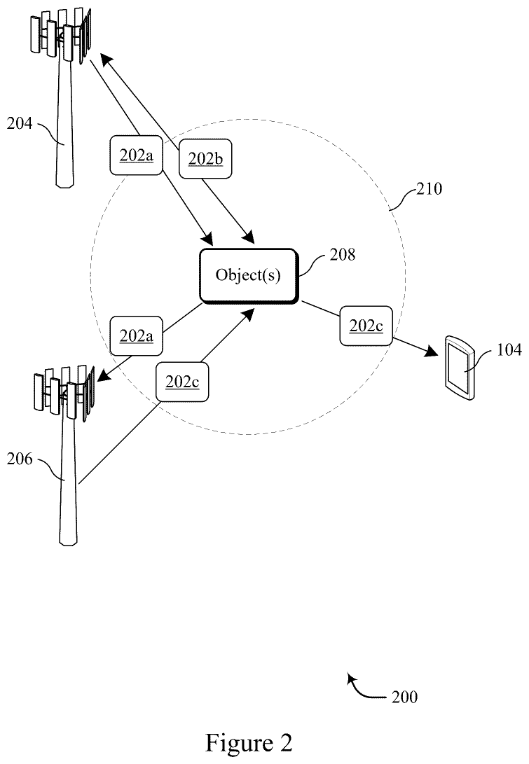

FIG. 2 illustrates an example wireless communication system 200 for radio sensing that supports configuration for radio sensing in accordance with aspects of the present disclosure. The wireless communication system 200 supports communication between UE 104, a first network node 204, and a second network node 206. The UE 104, the first network node 204, and the second network node 206 may communicate within an environment 210, e.g., a geographical area. The wireless communication system 200 may support a plurality of scenarios. The scenarios include:

Scenario 202a with a sensing Tx entity as a network node 204 and sensing Rx entity as a separate network node 206, which can represent different instances of NE 102: In the scenario 202a, the sensing reference signal (and/or another reference signal used for sensing or data and/or control channels known to the network TRP nodes) is transmitted and received by network entities 102. The involvement of UE nodes can be limited such as to aspects of interference management. The network may not utilize UEs for sensing assistance in the scenario 202a.

Scenario 202b with a sensing Tx entity as the network node 204 and sensing Rx entity as the same network node 204: In the scenario 202b, the sensing reference signal (and/or another reference signal used for sensing or the data and/or control channels known to the network TRP nodes) can be transmitted and received by the same network node 204, e.g., NE 102. The involvement of UE nodes can be limited such as to aspects of interference management. The network may not utilize UEs for sensing assistance in the scenario 202b.

Scenario 202c with a sensing Tx entity as the network node 206 and a sensing Rx entity as a UE 104: In the scenario 202c, the sensing reference signal or other reference signal used for sensing can be transmitted by the network node 206 (e.g., a NE 102) and received by one or multiple UEs 104. A network, for instance, configures the UE(s) 104 to act as a sensing Rx entity, such as according to the UE nodes capabilities for sensing and/or a specified sensing task.

As part of the scenarios 202a-202c, the radio sensing is implementing to detect feature characteristics of objects 208 present in the environment 210.

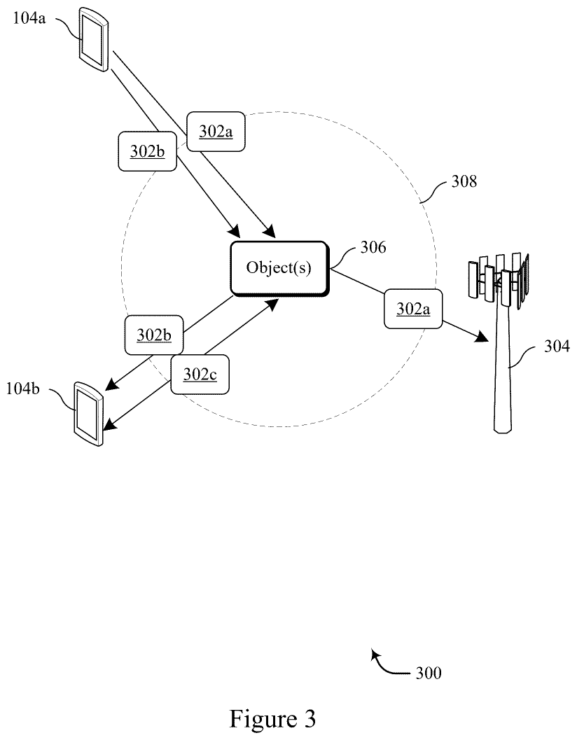

FIG. 3 illustrates an example wireless communication system 300 for radio sensing that support configuration for radio sensing in accordance with aspects of the present disclosure. The wireless communication system 300 supports communication between a UE 104a, a UE 104b, and a network node 304. The UE 104a, the UE 104b, and the network node 304 may communicate as part of detecting objects 306 within an environment 308, e.g., a geographical area. The scenarios depicted with reference to FIG. 2 and FIG. 3, for example, represent additional and/or alternative implementations. The wireless communication system 300 may support a plurality of scenarios. The scenarios include:

Scenario 302a with a sensing Tx entity as a UE 104a and sensing Rx entity as a network node 304: In the scenario 302a, the sensing reference signal or other reference signal used for sensing (and/or a data and/or control channel transmitted by the UE 104a) can be received by one or multiple NE 102 (e.g., the network node 304) and transmitted by the UE 104a. A network, for instance, configures the UE 104a to act as a sensing Tx entity, such as according to the UE 104a capabilities for sensing and/or a specified sensing task.

Scenario 302b with a sensing Tx entity as the UE 104a and a sensing Rx entity as a separate UE 104b: In the scenario 302b, the sensing reference signal or other reference signal used for sensing can be received by one or multiple UEs 104b and transmitted by the UE 104a. In this scenario, the network and/or a UE 104 may determine configuration for the sensing scenario. In at least one example, a network configures the UEs 104 to act as sensing Tx entities and/or sensing Rx entities, such as according to the UE 104 capabilities for sensing and/or a specified sensing task.

Scenario 302c with a sensing Tx entity as the UE 104b and sensing Rx entity as the same UE 104b: In the scenario 302c, the sensing reference signal (and/or another reference signal used for sensing and/or the data and/or control channels known to the UE) can be transmitted by the UE 104b and received by the same UE 104b. In at least one implementation, the UE 104b and/or a network configures the sensing scenario, such as according to the UE 104 capabilities for sensing and/or a specified sensing task.

The scenarios depicted herein are not intended to be restricted to a specific UE type, and may include any UE category. In the scenarios depicted herein, the roles elaborated for NE and/or UE may be replaced (with equal validity for any example of a radio sensing scenario) with any UE or RAN node, e.g., a smart repeater node, an integrated access and backhaul (IAB) node, a roadside unit (RSU), etc. In some examples, the set of sensing Tx entities of a sensing measurement process (and similarly, but optionally independently, sensing Rx entities of a sensing measurement process) include one or more of a TRP associated to a gNB-central unit (CU)/distributed unit (DU), a gNB-DU, a gNB-CU, a UE, a network controlled repeater (NCR), an IAB node, an RSU, or a dedicated sensing radio. In some implementations, a sensing Rx entity may be a non-3GPP sensor with capability of providing non-3GPP sensing data, or a 3GPP node (e.g., a UE or a RAN node) connected to the non-3GPP sensor that can obtain, process, and transfer the non-3GPP sensing data of the said non-3GPP sensor to other 3GPP nodes/entities.

Regarding sensing network architecture, integrated sensing and communication may enhance wireless (e.g., 5G) core architecture by introducing a new SF, such as discussed in the example scenarios below.

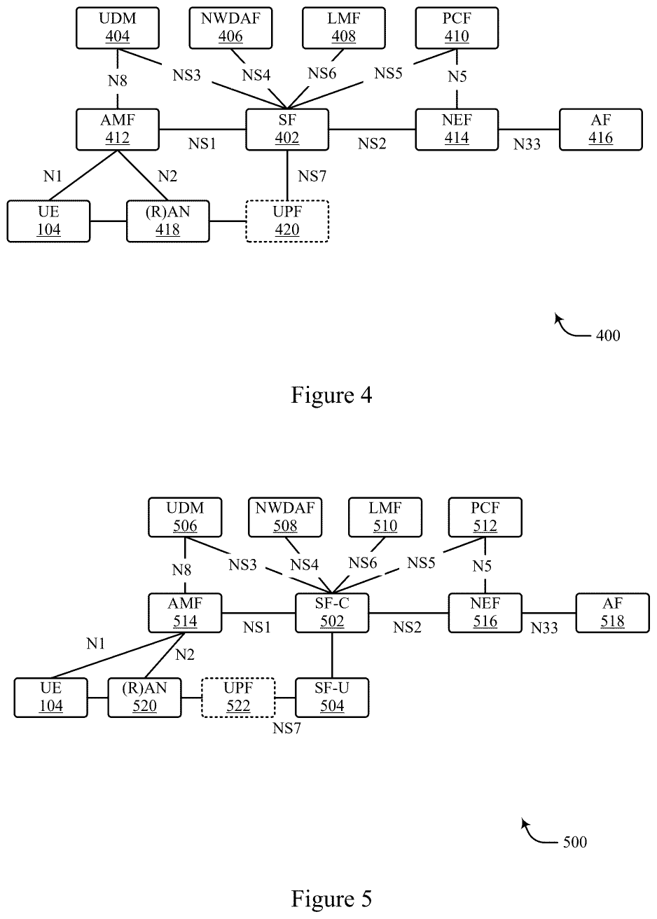

FIG. 4 illustrates an example scenario 400 for a tight coupling ISAC network architecture. The scenario 400 includes a SF 402, a unified data management (UDM) 404, a network data analytics function (NWDAF) 406, a LMF 408, a policy control function (PCF) 410, an access and mobility management function (AMF) 412, a network exposure function (NEF) 414, an application function (AF) 416, a UE 104, a RAN 418, and a UPF 420. Further, different reference points are illustrated with different “N” designations and represent interfaces between components of the scenario 400, such as reference point N1 between the UE 104 and the AMF 412, reference point N2 between the AMF 412 and the RAN 418, reference point N8 between the UDM 404 and the AMF 412, etc.

In the scenario 400 the SF 402 is implemented as a dedicated network function (NF) handling various tasks. For instance, the SF 402 can perform sensing control plane aspects such as the interaction with the sensing consumer via the NEF 414 and information exchange with other NFs, gathering UE 104 information, (e.g., from the AMF 412, UDM 404, LMF 408). The SF 402 can also obtain UE related policies from the PCF 410 and analytics from the NWDAF 406. The SF 402 may also manage the sensing radio signals for performing the analysis or prediction for determining a sensing target. With reference to the present disclosure, one or more entities in the scenario 400 can perform various implementations described herein for a configuration or sensing result entity and/or a measurement entity, such as the SF 402, nodes of the RAN 418, the UE 104, the LMF 408, etc.

FIG. 5 illustrates an example scenario 500 for a tight coupling ISAC network architecture. The scenario 500 includes a SF control plane (SF-C) 502, a SF user plane (SF-U) 504, a UDM 506, a NWDAF 508, an LMF 510, a PCF 512, an AMF 514, a NEF 516, an AF 518, a UE 104, a RAN 520, and a UPF 522. Further, different reference points are illustrated with different “N” designations and represent interfaces between components of the scenario 500, such as reference point N1 between the UE 104 and the AMF 514, reference point N2 between the AMF 514 and the RAN 520, reference point N8 between the UDM 506 and the AMF 514, etc.

In the scenario 500, a control plane/user plane (CP/UP) split is implemented where a SF has two dedicated NF counter parts: SF-C 502 that handles the control plane aspects as described above and SF-U 504 that is responsible for collecting the sensing radio signals via the user plane, e.g., via nodes of the RAN 520 and UPF 522. This architecture can split and offload heavy data volumes associated with sensing radio signals to the user plane to ensure light traffic (e.g., signaling) in the control plane. With reference to the present disclosure, one or more entities in the scenario 500 can perform various implementations described herein for a configuration or sensing result entity and/or a measurement entity, such as the SF-C 502, the SF-U 504, nodes of the RAN 520, the UE 104, the LMF 510, etc.

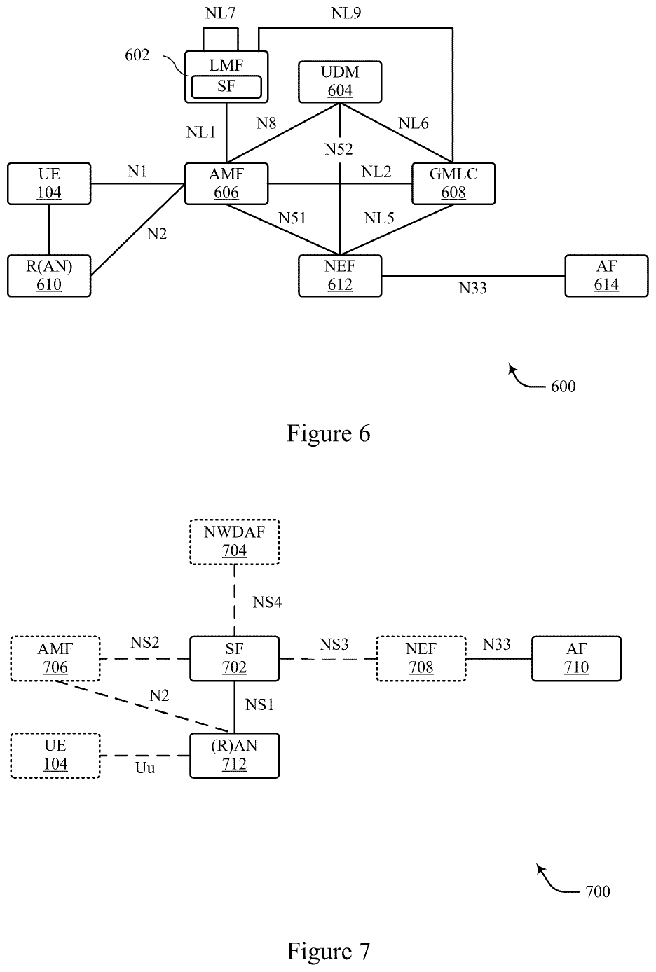

FIG. 6 illustrates an example scenario 600 where a SF is collocated with the LMF. The scenario 600 includes an SF/LMF 602, a UDM 604, a UE 104, an AMF 606, a gateway mobile location center (GMLC) 608, a RAN 610, a NEF 612, and an AF 614. Further, different reference points are illustrated with different “N” designations and represent interfaces between components of the scenario 600, such as reference point N1 between the UE 104 and the AMF 606, reference point N2 between the AMF 606 and the RAN 610, reference point N8 between the UDM 604 and the AMF 606, etc. In the scenario 600, the SF/LMF 602 is implemented as a logical NF embedded in the LMF to perform sensing taking advantage of the knowledge of the UE 104 location. With reference to the present disclosure, one or more entities in the scenario 600 can perform various implementations described herein for a configuration or sensing result entity and/or a measurement entity, such as the SF/LMF 602, nodes of the RAN 610, the UE 104, etc.

FIG. 7 illustrates an example scenario 700 for loose coupling ISAC network architecture. The scenario 700 includes a SF 702, a NWDAF 704, an AMF 706, a NEF 708, an AF 710, a UE 104, and a RAN 712. Further, different reference points are illustrated with different “N” designations and represent interfaces between components of the scenario 700, such as reference point N2 between the AMF 706 and the RAN 712, reference point NS2 between the SF 702 and the AMF 706, reference point NS3 between the SF 702 and the NEF 708, etc. In the scenario 700 the SF 702 is independent of the 5G core, e.g., the SF 702 can be used for local field scenarios or private networks and the interaction with the 5G core is minimal. One implementation is to use the SF 702 close to the RAN 712 (e.g., collect and process the sensing radio signals locally) and interact with 5G core for the purpose of exposure via the NEF 708, e.g., for obtaining the UE 104 location from the AMF 706 and for analytics, e.g., NWDAF 704. With reference to the present disclosure, one or more entities in the scenario 700 can perform various implementations described herein for a configuration or sensing result entity and/or a measurement entity, such as the SF 702, nodes of the RAN 712, the UE 104, etc.

In some example implementations, a sensing controller entity/function (e.g., sensMF, SMF, SF, SMC) is defined which includes one or multiple of a UE, a RAN node, a gNB/gNB-CU, an LMF, an SF, or a combination thereof. The sensMF can perform one or multiple of: (a) receiving requests for sensing information from a service consumer (e.g., a requesting third party application); (b) determining selection and/or configuration of a sensing operation, including configuration of one or more of a sensing Tx entity, sensing Rx entity; (c) selecting and/or configuring the involved nodes for sensing transmission and sensing reception and sensing measurement and reporting of the conducted measurements; (d) collecting the sensing measurements; (e) performing, configuring, and/or requesting computation of the sensing measurements and thereby determining sensing information based on the obtained sensing measurements; (f) reporting and/or exposing an obtained sensing information to the entity requesting the sensing information.

In some examples, a sensMF includes multiple nodes and/or entities, and one or more first aspects of the above-mentioned steps may be implemented by the first part of the sensMF and one or more second aspects of the above steps may be implemented by the second part of the sensMF, e.g., implemented in the SF and NE. In some examples, where the sensMF includes multiple nodes/entities, communication among the sensMF entities can be transparent to outside entities. Communication among the sensMF entities can be assumed to be implicit to the overall procedure. In some examples, where a sensMF is includes an SF and an NE (e.g., serving/head gNB of a related UE to the sensing task or a selected serving gNB for a sensing task), the SF can perform steps a, f, e, d (above) and the steps b, c can be performed by the selected NE, e.g., gNB node.

In some implementations the steps b, d above can be jointly performed by the SF and a selected NE (e.g., gNB), where a first aspect of the configuration/configuration determination can be performed by the SF and a second aspect of the configuration/configuration determination can be performed by the selected NE. The sensMF may be a RAN node (e.g., a selected gNB node acting as serving gNB of a sensing task), a SF residing in core network, a UE, and/or combinations thereof.

Communication and radar technologies have been deployed as separate/independent systems each with a separate waveform. There are, however, use cases (e.g., automotive, smart factory, medical monitoring, etc.) where joint radio communications and radar sensing using the same waveform are considered beneficial for efficient usage of the radio frequency (RF) spectrum as well usage of the same hardware to perform high data rate communications and precise ranging. Radar systems can be classified into the following categories: Monostatic radars: A radar system in which the transmitter and receiver are collocated; Bistatic radar: A radar system that includes a transmitter and receiver that are separated by a distance comparable to the expected target distance; Multistatic radar: A radar system which includes multiple spatially diverse monostatic radar or bistatic radar components within an overlapping coverage area.

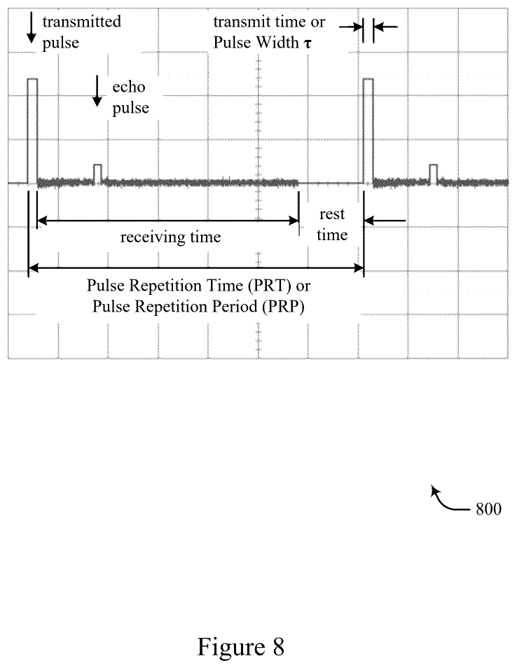

FIG. 8 illustrates an example 800 for transmit and echo pulse time domain representation. Radar signals are characterized by pulses that are modulated onto an RF carrier and are used to detect single/multiple objects that can be resolved in the time domain. In a scenario, for a single reflector, a pulse with measured round-trip time/allows the range (R) with respect to the object to be calculated as:

$$R = \frac{c t}{2}$$

While the range resolution (ΔR) is calculated as:

$$Δ R = \frac{c τ}{2}$$

Where τ is the pulse width and c is the speed of light. The radar pulses can be transmitted periodically so that range information can be provided in real time and wait for the returning echo signal during a rest/listening time (“rest time”) such as illustrated at 800.

With reference to RAT-dependent positioning measurements, different downlink (DL) measurements include DL positioning reference signal (PRS)-reference signal received power (RSRP), DL reference signal time difference (RSTD) and UE Rx-Tx Time Difference for the supported RAT-dependent positioning techniques are shown in Table 1. The following measurement configurations are specified: (1) 4 Pair of DL RSTD measurements can be performed per pair of cells. Each measurement is performed between a different pair of DL PRS Resources/Resource Sets with a single reference timing; (2) 8 DL PRS RSRP measurements can be performed on different DL PRS resources from the same cell.

TABLE 1
DL PRS reference signal received power (DL PRS-RSRP)

| | |
|---|---|
| Definition | DL PRS reference signal received power (DL PRS-RSRP), is defined as the |
| | linear average over the power contributions (in 14) of the resource elements that |
| | carry DL PRS reference signals configured for RSRP measurements within the |
| | considered measurement frequency bandwidth. |
| | For frequency range 1, the reference point for the DL PRS-RSRP can be the |
| | antenna connector of the UE. For frequency range 2, DL PRS-RSRP can be |
| | measured based on the combined signal from antenna elements corresponding |
| | to a given receiver branch. For frequency range 1 and 2, if receiver diversity is |
| | in use by the UE, the reported DL PRS-RSRP value may not be lower than the |
| | corresponding DL PRS-RSRP of any of the individual receiver branches. |
| Applicable for | RRC_CONNECTED intra-frequency, |
| | RRC_CONNECTED inter-frequency |

DL RSTD

| | |
|---|---|
| Definition | DL RSTD is the DL relative timing difference between the positioning node j |
| | and the reference positioning node i, defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD may be the antenna |
| | connector of the UE. For frequency range 2, the reference point for the DL |
| | RSTD may be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement may be the |
| | Rx antenna connector of the UE and the reference point for T_{UE-TX} measurement |
| | may be the Tx antenna connector of the UE. For frequency range 2, the |
| | reference point for T_{UE-RX} measurement may be the Rx antenna of the UE and |
| | the reference point for T_{UE-TX} measurement may be the Tx antenna of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS-RSRPP is defined as the power of the linear average of the channel |
| | response at the i-th path delay of the resource elements that carry DL PRS |
| | signal configured for the measurement, where DL PRS-RSRPP for the 1st path |
| | delay is the power contribution corresponding to the first detected path in time. |
| | For frequency range 1, the reference point for the DL PRS-RSRPP may be the |
| | antenna connector of the UE. For frequency range 2, DL PRS-RSRPP may be |
| | measured based on the combined signal from antenna elements corresponding |
| | to a given receiver branch. |
| Applicable for | RRC_CONNECTED, |
| | RRC_INACTIVE |

UL AoA

| | |
|---|---|
| Definition | UL AoA is defined as the estimated azimuth angle (A-AoA) and vertical angle |
| | (zenith (Z)-AoA) of a UE with respect to a reference direction, where the |
| | reference direction is defined: |
| | In the GCS, where estimated azimuth angle is measured relative to |
| | geographical North and is positive in a counterclockwise direction and |
| | estimated vertical angle is measured relative to zenith and positive to |
| | horizontal direction |
| | In the LCS, where estimated azimuth angle is measured relative to x-axis |
| | of LCS and positive in a counter-clockwise direction and estimated |
| | vertical angle is measured relative to z-axis of LCS and positive to x-y |
| | plane direction. The bearing, downtilt and slant angles of LCS are defined |
| | according to 3GPP technical specification (TS) 38.901. |
| | The UL-AoA is determined at the gNB antenna for an UL channel |
| | corresponding to this UE. |

UL Relative Time of Arrival (T_{UL-RTOA})

| | |
|---|---|
| Definition | The T_{UL-RTOA} is the beginning of subframe i including sounding reference signal |
| | (SRS) received in Reception Point (RP) j, relative to the RTOA Reference |
| | Time. |
| | The UL RTOA reference time is defined as T₀ + t_{SRS}, where |
| | T₀ is the nominal beginning time of system frame number (SFN) 0 |
| | provided by SFN Initialization Time [15, TS 38.455] |
| | t_{SRS} = (10n_{f} + n_{sf}) × 10⁻³, where n_{f} and n_{sf} are the system frame |
| | number and the subframe number of the SRS, respectively. |
| | Multiple SRS resources can be used to determine the beginning of one subframe |
| | including SRS received at a RP. |
| | The reference point for T_{UL-RTOA} may be: |
| | for type 1-C base station TS 38.104: the Rx antenna connector, |
| | for type 1-O or 2-O base station TS 38.104: the Rx antenna (i.e. the center |
| | location of the radiating region of the Rx antenna), |
| | for type 1-H base station TS 38.104: the Rx Transceiver Array |
| | Boundary connector. |

gNB Rx − Tx time difference

| | |
|---|---|
| Definition | The gNB Rx − Tx time difference is defined as T_{gNB-RX} − T_{gNB-TX} |
| | Where: |
| | T_{gNB-RX} is the Transmission and Reception Point (TRP) [18] received timing of |
| | uplink subframe #i including SRS associated with UE, defined by the first |
| | detected path in time. |
| | T_{gNB-TX} is the TRP transmit timing of downlink subframe #j that is closest in |
| | time to the subframe #i received from the UE. |
| | Multiple SRS resources can be used to determine the start of one subframe |
| | including SRS. |
| | The reference point for T_{gNB-RX} may be: |
| | for type 1-C base station TS 38.104: the Rx antenna connector, |
| | for type 1-O or 2-O base station TS 38.104: the Rx antenna (i.e. the center |
| | location of the radiating region of the Rx antenna), |
| | for type 1-H base station TS 38.104: the Rx Transceiver Array Boundary |
| | connector. |
| | The reference point for T_{gNB-TX} may be: |
| | for type 1-C base station TS 38.104]: the Tx antenna connector, |
| | for type 1-O or 2-O base station TS 38.104]: the Tx antenna (i.e. the |
| | center location of the radiating region of the Tx antenna), |
| | for type 1-H base station TS 38.104: the Tx Transceiver Array Boundary |
| | connector. |

UL SRS reference signal received path power (UL SRS-RSRPP)

| | |
|---|---|
| Definition | UL SRS-RSRPP is defined as the power of the linear average of the channel |
| | response at the i-th path delay of the resource elements that carry the received |
| | UL SRS signal configured for the measurement, where UL SRS-RSRPP for 1st |
| | path delay is the power contribution corresponding to the first detected path in |
| | time |
| | The reference point for UL SRS-RSRPP may be: |
| | for type 1-C base station TS 38.104 [9]: the Rx antenna connector, |
| | for type 1-O or 2-O base station TS 38.104 [9]: based on the combined |
| | signal from antenna elements corresponding to a given receiver branch |
| | for type 1-H base station TS 38.104 [9]: the Rx Transceiver Array |
| | Boundary connector. |
| | For frequency range 1 and 2, if receiver diversity is in use by the gNB for UL |
| | SRS-RSRPP measurements: |
| | The reported UL SRS-RSRPP value for the first and additional paths |
| | may be provided for the same receiver branch(es) as applied for UL SRS-RSRP |
| | measurements, or |
| | The reported UL SRS-RSRPP value for the first path may not be lower |
| | than the corresponding UL SRS-RSRPP for the first path of any of the |
| | individual receiver branches and the reported UL SRS-RSRPP for the additional |
| | paths shall be provided for the same receiver branch(es) as applied UL SRS- |
| | RSRPP for the first path. |

Regarding UL-AoA assistance information, an information element (IE) can include UL AoA and uncertainty range, such as shown in Table 2.

TABLE 2

| | | | IE Type and | |
|---|---|---|---|---|
| IE/Group Name | Presence | Range | Reference | Semantics Description |
| CHOICE | M | | | |
| AngleMeasurement | | | | |
| >Expected UL Angle | | | | |
| of Arrival | | | | |
| >>Expected | | 1 | | Defined as |
| Azimuth AoA | | | | (φ_{AOA} − Δφ_{AOA}/2, φ_{AOA} + |
| | | | | Δφ_{AOA}/2) |
| >>>Expected | M | | INTEGER(0 . . . | φ_{AOA} component of |
| Azimuth AoA | | | 3599) | Expected Azimuth AoA |
| Value | | | | |
| >>>Expected | M | | INTEGER(0 . . . | Δφ_{AOA} component of |
| Azimuth AoA | | | 3599) | Expected Azimuth AoA |
| Uncertainty Range | | | | |
| >>Expected Zenith | | 0 . . . 1 | | Defined as |
| AoA | | | | (θ_{ZOA} − Δθ_{ZOA}/2, θ_{ZOA} + |
| | | | | Δθ_{ZOA}/2) |
| >>>Expected | M | | INTEGER(0 . . . | θ_{ZOA} component of |
| Zenith AoA Value | | | 1799) | Expected Zenith AoA |
| >>>Expected | M | | INTEGER(0 . . . | Δθ_{ZOA} component of |
| Zenith AoA | | | 1799) | Expected Zenith AoA |
| Uncertainty Range | | | | |
| >Expected UL Angle | | | | Defined as |
| of Arrival Zenith | | | | (θ_{ZOA} − Δθ_{ZOA}/2, θ_{ZOA} + |
| Only | | | | Δθ_{ZOA}/2) |
| >>Expected Zenith | M | | INTEGER(0 . . . | θ_{ZOA} component of |
| AoA Value | | | 1799) | Expected Zenith AoA |
| >>Expected Zenith | M | | INTEGER(0 . . . | Δθ_{ZOA} component of |
| AoA Uncertainty | | | 1799) | Expected Zenith AoA |
| Range | | | | |
| LCS to GCS | O | | 9.2.69 | If absent, the azimuth and |
| Translation | | | | zenith are provided in |
| | | | | GCS. In case of zenith |
| | | | | only, the z-axis of LCS is |
| | | | | defined along the linear |
| | | | | array axis. |

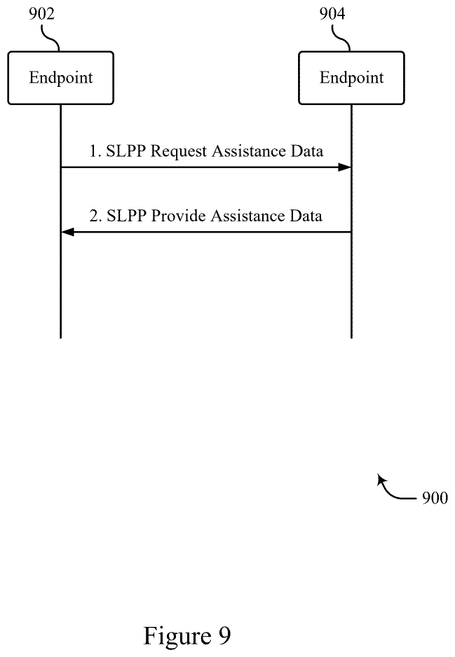

FIG. 9 illustrates at 900 example assistance data transfer operations for a positioning procedure. The scenario 900, for example, represents example assistance data transfer operations for SL-AoA for a positioning procedure. At (1) endpoint 902 may determine that SL-AoA positioning assistance data is to be obtained and sends a sidelink positioning protocol (SLPP) Request Assistance Data message to endpoint 904. This request includes an indication of which specific SL-AoA assistance data are requested.

At (2) endpoint 904 can provide the requested assistance in an SLPP Provide Assistance Data message to endpoint 902. Examples of the assistance data that may be signaled are listed in Table 3 below. If any of the requested assistance data in step (1) are not provided in step (2), endpoint 902 can assume that the requested assistance data are not supported, or currently not available at the endpoint 904. If none of the requested assistance data in step (1) can be provided by the endpoint 904, the endpoint 904 can return information that can be provided in an SLPP message of type Provide Assistance Data which includes a cause indication for the not provided assistance data. If step (1) did not occur, endpoint 904 can determine that SL-AoA assistance data is to be provided to endpoint 902 (e.g., as part of a positioning procedure) and can send an SLPP Provide Assistance Data message to endpoint 902.

Endpoint 902 may be a SL Target UE and endpoint 904 may be a SL Server UE or LMF. Alternatively, or additionally, endpoint 902 may be a SL Target UE or SL Server UE and endpoint 904 may be a SL Anchor UE. Alternatively, or additionally, endpoint 902 may be a SL-PRS transmitting (Tx) UE and endpoint 904 may be a SL-PRS receiving (Rx) UE.

TABLE 3
Information

Application Layer identifier (ID), identifying a UE as
defined in TS 23.287, for which the assistance data are
applicable
SL-PRS Sequence ID as defined in TS 38.211
Anchor UE location coordinates
SL-PRS Tx Antenna Reference Point (ARP) location
coordinates
SL-PRS Tx Information (SL-PRS Priority, SL-PRS
Delay Budget, SL-PRS Bandwidth, SL-PRS Periodicity,
SL-PRS Tx trigger indication)
Association information between SL-PRS Tx ARP-ID
and the already transmitted SL PRS resource(s)
Expected AoA and uncertainty

In aspects of this disclosure, solutions are provided for enhancing a sensing receiver to support operation by receiving assistance information relating to a beam sweep limit and/or scan limit (referred to herein as “beam sweep/scan limit”) and/or field of view information. For instance, solutions are described for defining the beam sweep/scan limit and field of view information associated to a sensing Rx entity depending on in part the location information of the one or more targets. Solutions are also described for defining scan modes to be employed at the sensing receiver to enable sensing operations according to the desired sensing service requirements. Solutions are also described to enable a procedural framework to support the exchange of the scan mode, beam sweep/scan limits, and/or field of view information between the configuration entity or sensing results computation entity and RAN entity or UE acting as a sensing Rx entity. The implementations described herein may be implemented in combination with each other to support an enhanced and coordinated method to perform sensing measurements. For the purposes of this disclosure, reference made to position information, location information, and/or estimates thereof may refer to an absolute position, relative position with respect to another node/entity, ranging in terms of distance, ranging in terms of direction, or combinations thereof. A sensing result may be delivered to an entity (e.g., sensing result consumer) such as an application function or service consumer upon a triggered request. For the purposes of this disclosure, derivation of sensing information and/or sensing result can be based on the initial measurements and input parameters, which may be different from the generated/reported sensing radio measurements.

As discussed herein, a sensing management function (SMF) and/or SF can manage coordination and scheduling of resources for the sensing of an object, e.g., a human and/or other physical object. The SMF/SF can calculate and/or verify a sensing result and/or velocity or doppler estimates, and may estimate the achieved sensing accuracy. The SMF/SF can receive sensing requests for a target within a network area by a sensing client, which may be external or internal to a network or device, respectively. The SMF/SF can interact with various network entities and UEs to exchange location information applicable to UE assisted and UE based sensing methods, and can interact with the NG-RAN to obtain sensing information. The SMF/SF, for example, is an example of a sensing result computation entity. A sensing management component (SMC) can represent all or part of the SMF/SF. The SMC may reside in the NG-RAN, and is another example of a sensing result computation entity.

Implementations described herein include procedures for determining doppler and velocity information of one or more targets in a wireless communication network. The implementations, for example, cover different use cases and scenarios in which sensing of one or more targets may be performed depending on different factors such as: (1) the wireless communication entity/node configuring the reference signal for sensing and/or communication purposes; (2) the wireless communication entity/node transmitting the reference signal; (3) the wireless communication entity/node receiving the reference signal and performing the measurement of the received reference signal; and/or (4) the wireless communication entity/node computing/determining the relevant sensing/radar metrics. Various combinations of wireless communication entities or nodes may be implemented to perform the described tasks based at least in part on the sensing scenarios, e.g., as illustrated in Table 4 below.

TABLE 4

| Scenario | Sensing Type | Description |
|---|---|---|
| TRP-TRP | Monostatic | A TRP of a gNB acts as a Sensing Transmitter while the same |
| | | TRP acts as Sensing Receiver. Also includes the case the quasi- |
| | | monostatic case, where a different TRP of the same gNB may |
| | | act as a sensing receiver, in which half-duplex operations are |
| | | supported. |
| UE-UE | Monostatic | A UE may act as a Sensing Transmitter while the same UE acts |
| | | as Sensing Receiver. |
| TRP-TRP | Bistatic | A TRP of a gNB acts as a Sensing Transmitter while another |
| | | TRP from different/neighboring gNB acts as a Sensing Receiver. |
| UE-UE | Bistatic | A UE acts as a Sensing Transmitter while another UE acts as a |
| | | Sensing Receiver. |
| TRP-UE | Bistatic | A TRP of a gNB acts as a Sensing Transmitter while a UE acts |
| | | as a Sensing Receiver. This UE may be served by the same gNB |
| | | acting as a Sensing Transmitter or different gNB. |
| UE-TRP | Bistatic | A UE acts as a Sensing Transmitter while a UE acts as a Sensing |
| | | Receiver. This UE may be served by the same gNB acting as a |
| | | Sensing Transmitter or different gNB. |

In implementations, one or more targets to be sensed may be categorized as follows: (1) device-free/passive—target includes an object not associated with the 3GPP network; (2) device-based/active-target is a human/object embedded with a UE, e.g., human holding a UE, UE embedded with a UAV, UE within automotive vehicles, etc.

In implementations, beam sweep/scan limit and field of view information can be generated and provided. For instance, a sensing measurement entity (e.g., a NE, TRP, gNB) may receive (e.g., from a configuration entity) beam sweep/scan limit information and field of view information, which may include one or more expected angle ranges and associated uncertainty information corresponding a sensing Rx entity's beam sweep/scan limit, which is directed towards a location of a target. A UE can perform Rx beam sweeping according to the direction received via transmission from the NE. The beam sweeping, for instance, can be based at least in part the best/strongest RSRP measurement of a configured reference signal (RS), e.g., synchronization signal block (SSB), channel state information (CSI)-RS, Tracking Reference Signal (TRS), etc. In the cases of sensing of one or more targets (e.g., bistatic scenario), the target(s) can be in any direction relative to the sensing Tx entity and sensing Rx entity. This beam sweep/scan limit information and field of view information can serve as assistance information to enable a measurement entity to set its antenna configuration and beam sweeping characteristics according to a particular scan mode based on the expected direction of the reflectors from a transmitted RS reflecting off one or more target(s) and a scenario of interest for target tracking/scanning.

In implementations, location information may correspond to various representations of geographical information. Examples of location information include cell identifiers (e.g., physical cell identity (PCI), NR cell global identifier (NCGI), TRP ID), area identifiers (e.g., tracking area (e.g., tracking area code (TAC)), RAN notification area), zone information, geographical information, location coordinates, etc. The value range or search window of the expected angle may be expressed in terms of angular values in degrees or radians covering azimuth, zenith, elevation angles of arrival from the measurement entity perspective. In implementations, angular values may be applicable to azimuth, zenith, elevation angles of departure (AoD) with respect to the sensing Tx entity. In at least one implementation, the expected angle range and uncertainty may be derived based on a priori information of a sensing target's absolute position/estimate or relative/range position/estimate of a target UE. In another implementation, the expected angle range and uncertainty may be predefined based on a target area of tracking and/or detection of one or more targets.

In implementations, the beam sweep/scan information for a measurement entity associated with one or more targets can refer to a sensing Rx entity antenna configuration to enable Rx beam sweeping in a predefined area. The Rx beam sweeping can be defined as the ability of a sensing receiver to tune its antenna configuration in the direction of the incoming signal. This can enable efficient sensing measurement without unnecessary scanning and searching for a target in an omnidirectional area based on different use cases, e.g., human detection in a specific indoor/outdoor area. This includes an implementation where one or more course or one or more narrow beams are used to cover a pre-defined area to be sensed.

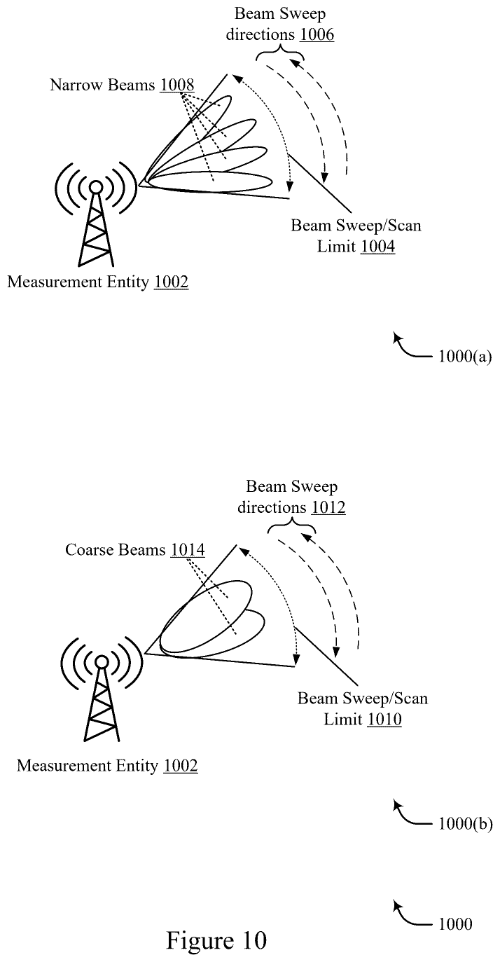

FIG. 10 illustrates example scenarios 1000 in accordance with aspects of the present disclosure. The scenarios 1000 include a scenario 1000(a) which illustrates narrow beam adjustment and a scenario 1000(b) which illustrates coarse beam adjustment. The scenarios 1000 include a measurement entity 1002 (e.g., a sensing Rx entity) and different beam sweep/scan limit attributes. For instance, the scenario 1000(a) includes a beam sweep/scan limit 1004, beam sweep directions 1006 (e.g., relative to the measurement entity 1002) and narrow beams 1008. The scenario 1000(b) includes a beam sweep/scan limit 1010, beam sweep directions 1012 (e.g., relative to the measurement entity 1002) and coarse beams 1014.

In implementations, the beam sweep/scan limits 1004, 1010 may include a start limit, end limit, rotational beam sweep direction (e.g., the beam sweep directions 1006, 1012, e.g., counterclockwise or clockwise), boresight with reference to the measurement entity 1002 elements (e.g., fields), which can be configured dynamically by a configuration entity to the measurement entity 1002. Information for the beam sweep/scan limits 1004, 1010 can be expressed in zenith, elevation, azimuth, or combinations thereof. In one implementation, Rx beams can be swept within a scan limit for a particular reference signal, e.g., DL-PRS, SRS, SRS for positioning, new sensing RS, CSI-RS, TRS, SSB, and so forth, or for one or more of the aforementioned reflected RS(s).

In implementations, a UE acting as a sensing Rx entity may be capable of either supporting and performing coarse Rx beam sweeping according to the beam sweep/scan limit 1010 or in other cases may support both coarse beam sweeping according to the beam sweep/scan limit 1010 and narrow beam sweeping according to the beam sweep/scan limit 1004. These options may affect the resolution and sweep/scan limit of the UE acting as a sensing Rx entity. To enable a suitable configuration of a beam sweep/scan limit, the UE may signal its beam management capabilities to assist in determining the sweep/scan limit, e.g., number of Rx beams, antenna reference point information, number of panels, number of antenna ports, and so forth. In at least one implementation, a beam sweep/scan limit can be configurable within a validity time interval. For instance, one beam sweep/scan limit A can be configured for X ms or seconds, another beam sweep/scan limit B can be configured for Y ms or seconds, and so forth. This can enable the sensing Rx entity to direct its receiver to the different sensing areas across different time intervals.

In implementations, received beam sweep/scan limits can be associated with validity criteria in terms of area or temporal validity criteria. In one implementation, the beam sweep/scan limits may be associated with one or more of the following temporal types of information: Validity time with start and end time, e.g., with time base coordinated universal time (UTC) or global navigation satellite system (GNSS) or SFN timing; Periodicity of each beam sweep within a configured scanning mode, e.g., in ms, seconds; Timer configuration via start timer, expiration timer, duration of timer; scanning mode timing window with start window, end window, window duration/length, timing offset.

In another implementation, the beam sweep/scan limits may be associated with one or more of the following area types of information: TRP-ID; DL-PRS-ID, or new Sensing RS ID; PCI ID; NCGI ID; NR or xG, e.g., 6G absolute radio frequency channel number (ARFCN); Area ID, Zone ID; Cell list index; Tracking area; RAN notification area. In implementations, beam sweeping within an indicated field of view/angular range information can be performed via implementation of the sensing Rx entity/sensing Tx entity by performing one or more of determining the Tx/Rx beams according to the received field of view/angular information. As such, the field of view/angular information and/or the associated timing information can be utilized by the sensing Tx entity/sensing Rx entity to determine and implement the configuration parameters for the beam sweeping operation.

In implementations, the field of view/angular information can be indicated to the sensing Tx entity/sensing Rx entity as part of the related configuration information of a beam sweeping procedure. In some such examples, the sensing Tx entity/sensing Rx entity can determine the K number of transmission beams according to the indicated field of view information and/or radiation pattern characteristics indicated as part of the field of view information. The configuration entity can share the expected field of view information, in which the sensing Rx entity can identify, detect and/or classify the one or more targets. Relevant information elements include the uptilt/downtilt antenna information and angular resolution, which can indicate the amount Rx antenna elements specified by the sensing Rx entity to distinguish two similar targets (e.g., similar RCS), which can avoid detecting two targets as one target. Another aspect of the field of view information can include different information elements that describe the receive beam antenna information including beam width and expected AoAs. Table 5 below includes a summary of IEs associated with the field of view information.

TABLE 5

| Parameter | Example Value | Description |
|---|---|---|
| > Uptilt | {True, False} | Indicates whether the Base |
| | | station/gNB/TRP may tune its |
| | | antenna configuration to the uptilt |
| | | direction. |
| > Downtilt | {True, False} | Indicates whether the Base |
| | | station/gNB/TRP may tune its |
| | | antenna configuration to the downtilt |
| | | direction. |
| >Expected Angular Resolution | | Defines the AoA angular resolution |
| | | value at the sensing Rx entity. It may |
| | | be defined as (φ_{A-AOA} − Δφ_{A-AOA})/2, |
| | | φ_{A-AOA} + Δφ_{A-AOA})/2) |
| >> expected-AzimuthAoA | Scale factor 0.1 | This information element indicates |
| | degree; range 0 to | the expected azimuth angle of |
| | 359.9 degrees | arrival (φ_{A-AOA}). In another |
| | | implementation, this IE can be used |
| | | to indicate azimuth scan range/beam |
| | | sweep range. |
| >> expected-AzimuthAoA- | Value indicates | This information element indicates |
| Uncertainty | maximum uncertainty | the (single-sided) uncertainty of the |
| | (X degrees). | expected azimuth angle of arrival |
| | Scale factor R degree; | (Δφ_{A-AOA}) |
| | range Xₘᵢₙ to Xₘₐₓ | |
| | degrees. | |
| >> expected-ElevationAoA | Scale factor 0.1 | This information element indicates |
| | degree; range 0 to | the expected elevation angle of |
| | 359.9 degrees | arrival (φ_{E-AOA}). In another |
| | | implementation, this IE can be used |
| | | to indicate elevation scan |
| | | range/beam sweep range. It may be |
| | | defined as (φ_{E-AOA} − Δφ_{E-AOA})/2, |
| | | φ_{E-AOA} + Δφ_{E-AOA})/2) |
| >> expected-ElevationAoA- | Value indicates | This information element indicates |
| Uncertainty | maximum uncertainty | the (single-sided) uncertainty of the |
| | (X degrees). | expected elevation angle of arrival |
| | Scale factor R degree; | (Δφ_{E-AOA}). |
| | range Xₘᵢₙ to Xₘₐₓ | |
| | degrees. | |
| >> expected- | Scale factor 0.1 | This information element indicates |
| BistaticAzimuthAoA | degree; range 0 to | the expected Bistatic azimuth angle |
| | 359.9 degrees | of arrival (φ_{Bi-AOA}) It may be defined |
| | | as (φ_{Bi-AOA} − Δφ_{Bi-AOA})/2, φ_{Bi-AOA} + |
| | | Δφ_{Bi-AOA})/2) |
| >> expected- | Value indicates | This information element indicates |
| BistaticAzimuthAoA- | maximum uncertainty | the (single-sided) uncertainty of the |
| Uncertainty | (X degrees). | expected Bistatic azimuth angle of |
| | Scale factor R degree; | arrival (Δφ_{Bi-AOA}) |
| | range Xₘᵢₙ to Xₘₐₓ | |
| | degrees. | |
| >> expected- | Scale factor 0.1 | This information element indicates |
| BistaticBisectorElevationAoA | degree; range 0 to | the expected Bistatic elevation angle |
| | 359.9 degrees | of arrival |
| >> expected- | Value indicates | This information element indicates |
| BistaticBisectorElevationAoA- | maximum uncertainty | the (single-sided) uncertainty of the |
| Uncertainty | (X degrees). | expected Bistatic elevation angle of |
| | Scale factor R degree; | arrival |
| | range Xₘᵢₙ to Xₘₐₓ | |
| | degrees. | |
| >> expected- | Scale factor 0.1 | This information element indicates |
| BistaticBisectorAzimuthAoA | degree; range 0 to | the expected Bistatic bisector |
| | 359.9 degrees | azimuth angle of arrival |
| >> expected- | Value indicates | This information element indicates |
| BistaticBisectorAzimuthAoA- | maximum uncertainty | the (single-sided) uncertainty of the |
| Uncertainty | (X degrees). | expected Bistatic bisector azimuth |
| | Scale factor R degree; | angle of arrival |
| | range Xₘᵢₙ to Xₘₐₓ | |
| | degrees. | |
| >> expected- | Scale factor 0.1 | This information element indicates |
| BistaticBisectorElevationAoA | degree; range 0 to | the expected Bistatic bisector |
| | 359.9 degrees | elevation angle of arrival |
| >> expected- | Value indicates | This information element indicates |
| BistaticBisectorElevationAoA- | maximum uncertainty | the (single-sided) uncertainty of the |
| Uncertainty | (X degrees). | expected Bistatic bisector elevation |
| | Scale factor R degree; | angle of arrival |
| | range Xₘᵢₙ to Xₘₐₓ | |
| | degrees. | |
| >ExpectedBeamwidthAzimuth | | Indicates the desired azimuth |
| | | beamwidth for the scan/beam sweep |
| | | area |
| >>Expected Azimuth Half Power | | Indicates the expected Azimuth |
| Beam Width (HPBW) | | angle between the half power points |
| | | of the main lobe as measured at −3 dB. |
| >>Expected Azimuth First Null | | Indicates the expected Azimuth |
| Beam Width (FNBW) | | degree of angular separation from |
| | | the main beam. It is found between |
| | | the null points of the main lobe of |
| | | the antenna's radiation pattern. |
| >ExpectedBeamwidthElevation | | Indicates the desired elevation |
| | | beamwidth for the scan/beam sweep |
| | | area |
| >>Expected Elevation Half | | Indicates the expected Elevation |
| Power Beam Width (HPBW) | | angle between the half power points |
| | | of the main lobe as measured at −3 dB. |
| >>Expected Elevation First Null | | Indicates the expected Elevation |
| Beam Width (FNBW) | | angle between the half power points |
| | | of the main lobe as measured at −3 dB. |
| >ExpectedTargetRCSList | Value range in terms | Indicates the expected RCS of the |
| | of dBsqm or m² | one or more targets in the form of a |
| | | list/index. |
| >ExpectedSensingResolution | | Indicates the ability of a sensing Rx |
| | | entity between two or more targets. |
| | | In a 3-D space, the resolution bin of |
| | | a radar is formed by the azimuth |
| | | boundary, elevation boundary, and |
| | | range boundary. If two targets fall |
| | | within the same resolution bin, then |
| | | the sensing Rx entity cannot |
| | | distinguish between them and may |
| | | inaccurately reports them as one |
| | | target sensing result computation |
| | | entity. |
| >BeamSweepDirection | Value range in terms | Indicates the recommended/desired |
| | of {clockwise, | beam sweep direction of the sensing |
| | anticlockwise} or | Rx entity. |
| | related rotations in | |
| | terms of degrees or | |
| | radians in clockwise | |
| | or anticlockwise | |
| | direction | |
| >sensingTxLocationIndex | | Indicates an index of the Location |
| | | coordinates/information of the |
| | | sensing Tx(s) |
| >>sensingTxLocation | | Indicates the location coordinates of |
| | | the sensing Tx(s) and location |
| | | coordinates of antenna reference |
| | | points for RS for sensing resource |
| | | sets and RS for sensing resources for |
| | | sensing Tx(s). |
| >>sensingTxLocationUncertainty | | Indicates the uncertainty of the |
| | | location coordinates of the sensing |
| | | Tx(s). |
| >ExpectedRange | | Indicates the expectedRange |
| | | between the sensing Rx entity and |
| | | Target. In other implementations, it |
| | | could also indicate the expected |
| | | range between Sensing Tx and |
| | | target. |
| >ExpectedRangeUncertainty | | Indicates the expectedRange |
| | | uncertainty between the sensing Rx |
| | | entity and Target. In other |
| | | implementations, it could also |
| | | indicate the expected range |
| | | uncertainty between Sensing Tx and |
| | | target. |

In implementations, the configuration entity may provide GCS-LCS translation parameters for the beam sweep/scan limit and field of view information, where the GCS is defined as (x, y, z, θ, φ) and unit vectors (\hat{θ}, \hat{φ}) and LCS is defined with primed coordinates in terms of (x′, y′, z′, θ′, φ′) and primed unit vectors (\hat{θ}′, \hat{φ}′). The GCS-LCS translation parameters may include angles α (bearing angle), β (downtilt angle) and γ (slant angle). In some implementations, the configuration entity, upon reception of the information describing the LCS of a sensing radio node (e.g., sensing Tx entity, sensing Rx entity) from the sensing the radio node, can translate the angle, field of view, and/or beam related information according to the received LCS information of the sensing radio node prior to sending the GCS-LCS translation information to the sensing radio node.

In implementations, the coordinate system (CS) (e.g., LCS, GCS) of a first radio node (e.g., sensing Tx entity, sensing Rx entity) can be transferred (e.g., upon a request received from the configuration entity or a second radio node, or autonomously by the first radio node) to the second radio node (e.g., sensing Tx entity, sensing Rx entity) via one or more of: (1) Indication of one or more parameters of angles α (bearing angle), β (downtilt angle) and γ (slant angle) in relation to a known/indicated CS to the second radio node; (2) Indication of the AoD/zenith of departure (ZoD) information of a transmitted signal according to the said CS by the first radio node, where the AoA/zenith of arrival (ZoA) of the signal from the direct path can be measured by the second radio node; (3) Indication of the AoA/ZoA information of a received signal according to the CS by the first radio node, for which the AoD/ZOD of the signal within the direct path is known by the second radio node.

In implementations, all or subsets of the parameters defining the CS can be obtained by the first radio node and/or the second radio node according to an available input from a RAT-independent sensor. For instance, the RAT-independent sensor may provide the direction of zenith or direction towards a jointly known destination/common reference axis, e.g., sun, earth center, magnetic north, truth north, etc. In some such implementations, the availability, accuracy, and time-validity of the RAT-independent CS information can be indicated by the first radio node. In some such implementations, the utilization of the RAT-independent CS information can be indicated/configured by the first radio node or the second radio node. In some examples, the first radio node and/or the second radio node are one or more of a gNB/TRP, the SensMF, LMF, SF, SMC, a UE, sensing Tx entity, sensing Rx entity, etc.

In implementations, expected field of view information assists in configuring a sensing Rx entity based on different use cases. A wider field of view can enable the sensing Rx entity to increase the area to be sensed as well as the number of targets to be concurrently detected, classified, and/or tracked. A wider field of view can additionally provide enhanced situational awareness to enhance the sensing result computation, while reducing the blind spots since the field of view spans a larger area. A finer/narrower field of view can allow for higher antenna gain, which can enable the sensing Rx entity to increase its sensitivity to detect weaker paths. Additionally, a finer/narrower field of view can also allow for enhanced target tracking performance within a field of view.

In implementations, beam sweep/scan limit and/or field of view information can be provided to the measurement entity/sensing Rx entity (e.g., SF, SMC) based on prior received information including target location information and/or capability information regarding the supported scan modes by the sensing receiver. In at least one scenario, some sensing receivers may support one or more beam sweep/scan limits and/or field of information based on antenna configuration. In such scenarios the configuration/sensing result computation entity may receive the capability information from the one or more measurement entities/sensing Rx entities prior to configuring the beam sweep/scan limit and/or field of view information of the one or more measurement entities/sensing Rx entities.

In implementations, parameters included in Table 5 above may be applicable to a sensing Tx entity with one difference being that the expected AoD can be considered alternatively or additionally to the described AoA-related parameters, e.g., expected-AzimuthAoA and expected-AzimuthAoA-Uncertainty can become expected-AzimuthAoD and expected-AzimuthAoD-Uncertainty, and so forth. Additionally, this can provide information on which AoDs are optimal to obtain the best range/delay, doppler and angular reflected signal profiles of the one or more targets based on the geographic or geometric distribution of the one or more sensing Rx entities.

Implementations described herein can also utilize different scanning types. For instance, a configuration entity can configure the sensing scan mode type at the measurement entity, e.g., TRP or UE. In one implementation, a sensing scan mode can enable the sensing Rx entity to detect, classify, and/or track a target in 3D space, while other implementations may consider 2D space or a combination of scan modes in both 2D or 3D space. Table 6 below illustrates examples of different scan modes which can be enabled. A sensing scan mode can also enable the sensing Rx entity to update, modify, and/or adjust its antenna configuration (e.g., beamforming weights) to anticipate one or more targets.

TABLE 6

| Parameter | Description |
|---|---|
| > Scanning Mode | Indicates the method of scanning |
| | mode to be employed at the Sensing |
| | Rx |
| >> E-scan | Utilizes a phased array approach to |
| | steer the beam based on adjusting the |
| | phase of the beamforming weights. |
| | This does not involve any physical |
| | movement of the antennas. |
| >> M-scan | Utilizes mechanical motors to |
| | manually to steer the antenna along |
| | the azimuth and elevation angles to |
| | the desired sensing area/field of view |
| >> Hybrid scan | Utilizes a combination of E-scan and |
| | M-scan methods to steer the Rx |
| | beams to the desired sensing |
| | area/field of view. |
| >> Sector Scan | Utilizes a beam sweep across the |
| | received specified field of view |
| | information. In one implementation, |
| | the sector scan performs beam |
| | sweeping of limited area usually less |
| | than 360 degrees. In another |
| | implementation, the sector scan can |
| | include a scan across a sector of a |
| | cell, e.g., communication cell, |
| | indicated with an associated PCI. |
| >> Raster Scan | Utilizes a beam/scan sweep pattern, |
| | where the beams are sequentially |
| | swept to cover rectangular or square |
| | area. In other implementations, the |
| | area to be covered maybe similar to |
| | polygon. |
| >> Conical Scan | The beam/scan sweep pattern rotates |
| | in a conical 3D shape in the vicinity |
| | of the target, assuming the target |
| | location information is known. This |
| | enables precise tracking of the target |
| | over time based within the sensing |
| | area/field of view. |
| >> Cell Scan | The beam/scan sweep pattern |
| | involves the traditional approach of |
| | beam sweeping a cell depending on |
| | the number of beams supported, |
| | which may vary based on frequency |
| | range of operation, e.g., FR1, FR2 or |
| | FR3. |
| >> Helical Scan | The beam/scan sweep pattern spirals |
| | inwards or outwards in the sensing |
| | area/field of view in 3D space. |
| | Associated information which may |
| | also be signaled along with the scan |
| | mode may include an inward or |
| | outward indication. |
| >> Spiral Scan | The beam/scan sweep pattern spirals |
| | inwards or outwards in the sensing |
| | area/field of view in 2D space. |
| | Associated information which may |
| | also be signaled along with the scan |
| | mode may include an inward or |
| | outward indication. |
| >> Track-while-Scan | The scanning mode involves two |
| | simultaneous processes including |
| | scanning the sensing area/field of |
| | view while tracking previously |
| | detected one or more targets. This |
| | can originate from different sensing |
| | service requests and enables multi- |
| | target tracking. |
| >> One Shot Scan | The scanning mode may utilize a |
| | single sweep pattern to estimate the |
| | targets' direction/location |
| | information. This may be based on |
| | the measurement of single RS |
| | transmission occasion from the |
| | sensing Tx entity. |
| >> Spotlight Scan | This scanning mode focuses on a |
| | smaller area within the field of view, |
| | sensing area. This focused scanning |
| | mode enables higher resolution and |
| | accuracy by adjusting the coherent |
| | processing gain to this “spotlight” |
| | area. |
| >> Boresight Scan | The scanning mode enables the |
| | beam pattern to be fixed in a specific |
| | area, i.e. the boresight direction of |
| | the Rx antenna. |
| >>>Depth/Volumetric related | This parameter may be further |
| parameters | associated with the any of the above |
| | scan modes to indicate the depth or |
| | volumetric parameters of any of the |
| | scan modes. For example, higher |
| | depth information of a Raster scan |
| | increase the coverage of the scan but |
| | may decrease the resolution and |
| | lower depth information decrease the |
| | potential coverage of the scan but |
| | increase the sensing resolution |
| | accuracy. |

In implementations, a scan mode may be associated with temporal information informing the validity of the scanning mode. In at least one implementation, a scan mode may be configured for the duration of the sensing session. Alternatively or additionally, a scan mode may be associated with one or more of the following temporal types of information: Validity time with start and end time, e.g., with time base UTC or GNSS or SFN timing; Periodicity of each beam sweep within a configured scanning mode, e.g., in milliseconds, seconds; Timer configuration via start timer, expiration timer, duration of timer; Scanning mode timing window with start window, end window, window duration/length, offset.

In implementations, a scan mode may be associated with one or more of the following types of area information: TRP-ID; DL-PRS-ID, or new Sensing RS ID; PCI ID; NCGI ID; NR or xG, e.g., 6G ARFCN; Area ID, Zone ID; Cell list index; Tracking area; RAN notification area. In implementations, the geometrical features of a scan mode may also be provided along with a scan mode indication, e.g., from Table 6. These may include but are not limited to the following:

Raster Scan: Associated geometric property information may include (x,y) vertex locations in the case of a 2D Rectangle/Square and (x,y,z) vertex locations in the case of a 3D Rectangle/Square.

Conical Scan: Associated geometric property information may include the base of the cone with radius r, apex height of right circular cone (apex is directly above the center of the base), apex height of an oblique cone (apex is not directly of the above the center of the base), and/or slant height.

Helical Scan: The helical axis may first be located in 3D space based on a reference axis related to the target or the scan/beam sweep area. The helical axis is defined as the normal vector to the plane onto which the helix projects a circle. A rotation matrix, R, is defined which relates the old coordinates of the points to rotated coordinates of the points. The original coordinates of the points are given by (x₀, y₀, z₀) and the rotated coordinates are denoted (x′, y′, z′). A unit normal vector, \hat{n}, representing the plane (ax₀+by₀+cz₀=0) including the coordinates (x₀, y₀, z₀) is defined using direction cosines, \hat{n}=(a, b, c). The basis vectors (êₓ_{₀}, ê_{y}_{₀}, ê_{z}_{₀}) and (ê_{x′}, ê_{y′}, ê_{z′}) represent the frame of the original coordinates (x₀, y₀, z₀) and the rotated coordinates (x′, y′, z′), respectively. The unit vector êz, is chosen to be the unit normal vector of the plane (a, b, c) given by: ê_{z′}=aêₓ_{₀}+bê_{y}_{₀}+cê_{z}_{₀}. In addition, the spherical coordinates, may be used to rotate the helix frame over all possible orientations in 3D space. The Rotation of a helical scan in 3D space can be given as follows:

$$( \begin{matrix}x \\ y \\ z\end{matrix} ) = ( \begin{matrix}\frac{1}{μ} & - ab μ & - ac μ \\ 0 & c μ & - b μ \\ a & b & c\end{matrix} ) ( \begin{matrix}{x}_{0} \\ {y}_{0} \\ {z}_{0}\end{matrix} ) ,$$

where a=sin φ cos α, b=sin φ sin α, c=cos φ, φ and α are the two polar spherical coordinates bounded by [0,180°] and [0,360°], respectively while

$$μ = \frac{1}{\sqrt{1 - {a}^{2}}} .$$

Spiral Scan: Associated geometric property information may be defined by a logarithmic spiral in one implementation, given by: r=ae^{θ cot b}, where r is the radius of each turn of the spiral, a and b are defined as constants according to the spiral, θ is the angle of rotation as the curve spirals.

Spotlight Scan: In one implementation the spotlight scan be circular with associated radius r and/or diameter d. The centre of the spotlight scan is associated with approximate or precise location information of the target and a beamwidth or footprint defined by the described radius r and/or diameter d.

In implementations, the above-described geometric parameters can assist in performing a beam sweep/scan according to a specified geometry, which in turn can determine the beamforming properties of the receiver. According to the above scan modes, coarse or precise location information may be specified, e.g., absolute 2D/3D location, relative 2D/3D location, range and/or direction between Tx and Rx of the one or more targets, etc. The slant range or range can apply to one or more of the scan modes, which refers to the sensing Rx entity to target distance/range, can affect the resolution of the scan mode. For instance, a higher slant range may reduce the scan resolution (e.g., azimuth/elevation angular or range resolution) with the benefit of better coverage.

In implementations, the sensing mode can be provided to the measurement entity and/or sensing Rx entity based on prior received capability information regarding the supported scan modes by the sensing Rx entity. One scenario may include that some sensing Rx entities may support one or more sensing modes and a configuration/sensing result computation entity may receive the capability information from the sensing Rx entities prior to configuring the sensing scan mode of the sensing Rx entities.

Implementations also provide aspects of procedural frameworks for requesting, configuring, and providing information parameters to enable enhanced sensing operations including the beam sweep/scan limit, field of view search information, and/or sensing mode with associated information. The discussion below, for example, presents example procedures for a RAN entity as a sensing Rx entity and a UE as a sensing Rx entity, respectively.

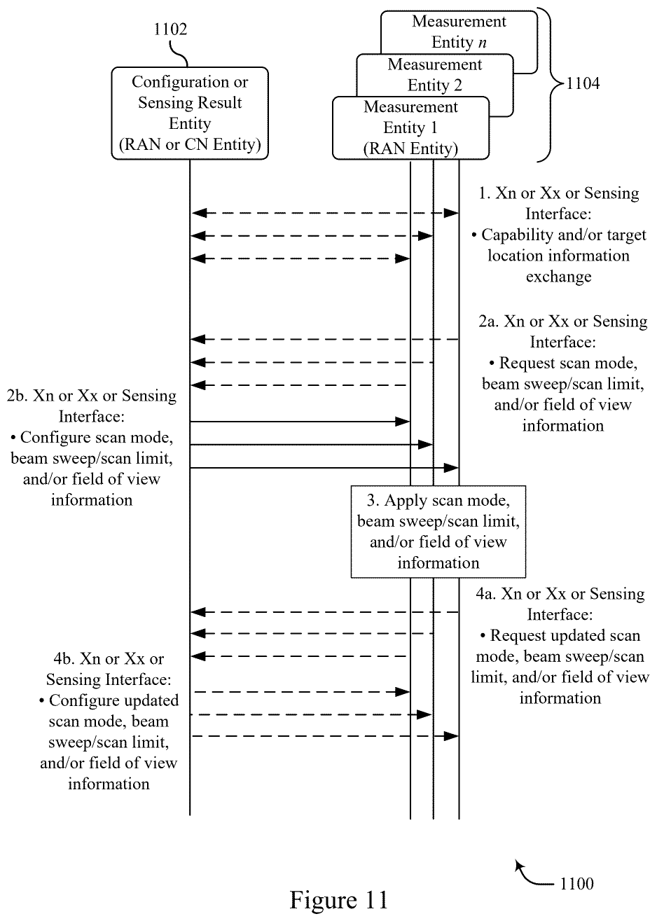

FIG. 11 illustrates a signaling diagram 1100 in accordance with aspects of the present disclosure. The signaling diagram 1100 includes a configuration or sensing result entity 1102 and measurement entities 1104, e.g., sensing Rx entities. The configuration or sensing result entity 1102 can represent an entity that configures a measurement entity 1104 with various sending configuration and/or sensing parameters described herein. Alternatively, or additionally, the configuration or sensing result entity 1102 can represent an entity that performs sensing result computation, such as based on sensing measurements received from the measurement entities 1104. The configuration or sensing result entity 1102 can be implementation in various ways, such as a RAN entity or a CN entity. The measurement entities 1104 can represent sensing Rx entities that are configured with sensing configuration information and/or parameters such as described herein, and may be implemented as RAN entities. The measurement entities 1104 can receive different types of RS, perform measurements on the RS, and transmit the measurements to different entities such as the configuration or sensing result entity 1102. The signaling diagram 1100 includes the following steps:

Step 1: Prior capability and/or target location information can be exchanged on scan mode, beam sweep/scan limit, and/or field of view information to ascertain parameters to be configured between the configuration or sensing result entity 1102 and measurement entities 1104.

Step 2: This exchange involves the request and subsequent provision of the scan mode, beam sweep/scan limit, and/or field of view information. Step 2 may use RAN-RAN interface signaling, e.g., Xn or Xx or CN-RAN interface signaling, which can include a new sensing interface or NRPPa.

Step 2a: The measurement entities 1104 may optionally request for the scan mode, beam sweep/scan limit, and/or field of view information based on its relative location to the one or more targets and sensing service parameters associated with a sensing request, e.g., sensing QoS, detection parameters, and so forth.

Step 2b: The configuration or sensing result entity 1102 may provide the scan mode, beam sweep/scan limit, and/or field of view information to one or more measurement entities 1104 in a solicited manner (e.g., based on execution of Step 2a) or an unsolicited manner.

Step 3: The measurement entities 1104 may apply the received the scan mode, beam sweep/scan limit, and/or field of view information, such as part of receiving and measuring sensing signals.

Step 4: This exchange involves the request and subsequent provision of updated scan mode, beam sweep/scan limit, and/or field of view information, e.g., when radio conditions or other conditions change during an ongoing sensing session. The update may use RAN-RAN interface signaling, e.g., Xn or Xx or CN-RAN interface signaling, which can include new sensing interface or NRPPa.

Step 4a: The measurement entities 1104 may optionally request for the updated scan mode, beam sweep/scan limit, and/or field of view information in an on-demand manner based on its updated relative location to the one or more targets and sensing service parameters associated with a sensing request, e.g., sensing QoS, detection parameters, and so forth.

Step 4b: The configuration or sensing result entity 1102 may provide the updated scan mode, beam sweep/scan limit, and/or field of view information to one or more measurement entities 1104 in a solicited manner (e.g., based on execution of Step 4a) or an unsolicited manner.

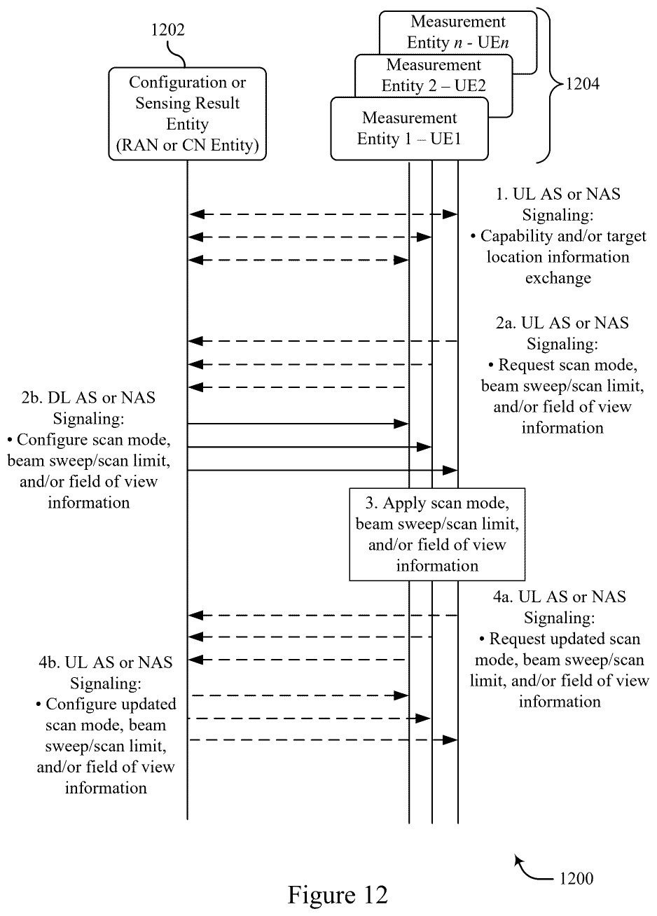

FIG. 12 illustrates a signaling diagram 1200 in accordance with aspects of the present disclosure. The signaling diagram 1200 includes a configuration or sensing result entity 1202 and measurement entities 1204, e.g., sensing Rx entities. The configuration or sensing result entity 1202 can represent an entity that configures a measurement entity 1204 with various sending configuration and/or sensing parameters described herein. Alternatively, or additionally, the configuration or sensing result entity 1202 can represent an entity that performs sensing result computation, such as based on sensing measurements received from the measurement entities 1204. The configuration or sensing result entity 1202 can be implementation in various ways, such as a RAN entity or a CN entity. The measurement entities 1204 can represent sensing Rx entities that are configured with sensing configuration information and/or parameters such as described herein, and may be implemented as UEs. Further the measurement entities 1204 can receive different types of RS, perform measurements on the RS, and transmit the measurements to different entities such as the configuration or sensing result entity 1202. The signaling diagram 1200 includes the following steps:

Step 1: Prior capability and/or target location information can be exchanged on scan mode, beam sweep/scan limit, and/or field of view information to ascertain parameters to be configured between the configuration or sensing result entity 1202 and measurement entities 1204.

Step 2: This exchange involves the request and subsequent provision of the scan mode, beam sweep/scan limit, and/or field of view information. Step 2 may use a combination of UL and DL interface signaling, e.g., new sensing interface protocol, lower layer signaling (e.g., uplink control information (UCI)/downlink control information (DCI), medium access control (MAC) control element (CE)), or higher layer signaling, e.g., radio resource control (RRC), LTE positioning protocol (LPP) or new sensing protocol.

Step 2a: The measurement entities 1204 may optionally request for the scan mode, beam sweep/scan limit, and/or field of view information based on its relative location to the one or more targets and sensing service parameters associated with a sensing request, e.g., sensing QoS, detection parameters, and so forth.

Step 2b: The configuration or sensing result entity 1202 may provide the scan mode, beam sweep/scan limit, and/or field of view information to one or more measurement entities 1204 in a solicited manner (e.g., based on execution of Step 2a) or an unsolicited manner.

Step 3: The measurement entities 1204 may apply the received the scan mode, beam sweep/scan limit, and/or field of view information, such as part of receiving and measuring sensing signals.

Step 4: This exchange involves the request and subsequent provision of updated scan mode, beam sweep/scan limit, and/or field of view information, e.g., when radio conditions or other conditions change during an ongoing sensing session. The update may use a combination of UL and DL interface signaling, e.g., new sensing interface protocol, lower layer signaling (e.g., UCI/DCI, MAC CE), or higher layer signaling, e.g., RRC, LPP, sensing protocol.

Step 4a: The measurement entities 1204 may optionally request for the updated scan mode, beam sweep/scan limit, and/or field of view information in an on-demand manner based on its updated relative location to the one or more targets and sensing service parameters associated with a sensing request, e.g., sensing QoS, detection parameters, and so forth.

Step 4b: The configuration or sensing result entity 1202 may provide the updated scan mode, beam sweep/scan limit, and/or field of view information to one or more measurement entities 1204 in a solicited manner (e.g., based on execution of Step 4a) or an unsolicited manner.

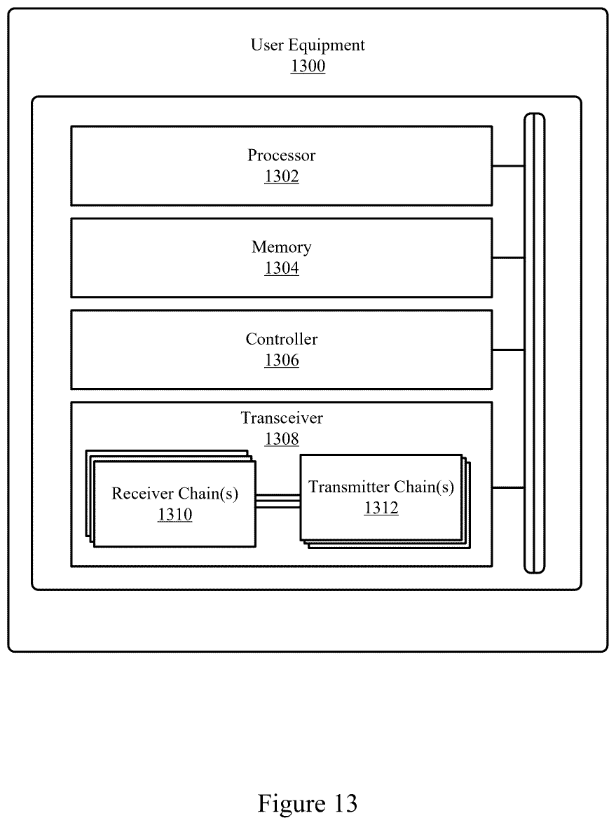

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions when executed by the processor 1302 cause the UE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to or operable to support a means for receiving configuration information including one or more parameters associated with identifying a field of view; receiving a reference signal based at least in part on a receive antenna configuration, where the receive antenna configuration is based at least in part on the configuration information; and performing at least one sensing measurement based at least in part on the reference signal.

Additionally, the UE 1300 may be configured to support any one or combination of where the configuration information includes an expected target field of view and uncertainty information associated with the expected target field of view; the configuration information indicates scan limit information including one or more of: at least one minimum scan limit, at least one maximum scan limit, at least one minimum beam sweep limit, at least one maximum beam sweep limit, or at least one beam sweep direction; the configuration information further includes field of view information elements, where the field of view information elements includes one or more of: an uptilt indication, a downtilt indication, an expected angular resolution, an expected angular uncertainty, an expected bistatic angular information, an expected beam power, or an expected beamwidth; the configuration information further includes LCS to GCS translation parameters including one or more of a bearing angle, a downtilt angle, or a slant angle.

Additionally, the UE 1300 may be configured to support any one or combination of where the configuration information further includes one or more scan mode indications, and where each of the one or more scan mode indications is based at least in part on a respective type of scan mode; the configuration information includes one or more of field of view information, scan limit information, or scan mode information; the one or more of the field of view information, the scan limit information, or the scan mode information is associated with validity criteria; and the validity criteria includes one or more of a temporal validity criterion or an area validity criterion; further including one or more of: requesting one or more of updated field of view information, updated scan limit information, or updated scan mode information; or receiving one or more of updated field of view information, updated scan limit information, or updated scan mode information; further including transmitting a reference signal based at least in part on a transmit antenna configuration, where the transmit antenna configuration is based at least in part on the configuration information.

Additionally, or alternatively, the UE 1300 may support at least one memory (e.g., the memory 1304) and at least one processor (e.g., the processor 1302) coupled with the at least one memory and configured to cause the UE to receive configuration information including one or more parameters associated with identifying a field of view; receive a reference signal based at least in part on a receive antenna configuration, where the receive antenna configuration is based at least in part on the configuration information; and perform at least one sensing measurement based at least in part on the reference signal.

Additionally, the UE 1300 may be configured to support any one or combination of where the configuration information includes an expected target field of view and uncertainty information associated with the expected target field of view; the configuration information indicates scan limit information including one or more of: at least one minimum scan limit, at least one maximum scan limit, at least one minimum beam sweep limit, at least one maximum beam sweep limit, or at least one beam sweep direction; the configuration information further includes field of view information elements, the field of view information elements includes one or more of: an uptilt indication, a downtilt indication, an expected angular resolution, an expected angular uncertainty, an expected bistatic angular information, an expected beam power, or an expected beamwidth; the configuration information further includes LCS to GCS translation parameters including one or more of a bearing angle, a downtilt angle, or a slant angle.

Additionally, the UE 1300 may be configured to support any one or combination of where the configuration information further includes one or more scan mode indications, and where each of the one or more scan mode indications is based at least in part on a respective type of scan mode; the configuration information includes one or more of field of view information, scan limit information, or scan mode information; the one or more of the field of view information, the scan limit information, or the scan mode information is associated with validity criteria; and the validity criteria includes one or more of a temporal validity criterion or an area validity criterion; the at least one processor is configured to cause the UE to one or more of: request one or more of updated field of view information, updated scan limit information, or updated scan mode information; or receive one or more of updated field of view information, updated scan limit information, or updated scan mode information; the at least one processor is configured to cause the UE to transmit a reference signal based at least in part on a transmit antenna configuration, where the transmit antenna configuration is based at least in part on the configuration information.

The controller 1306 may manage input and output signals for the UE 1300. The controller 1306 may also manage peripherals not integrated into the UE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

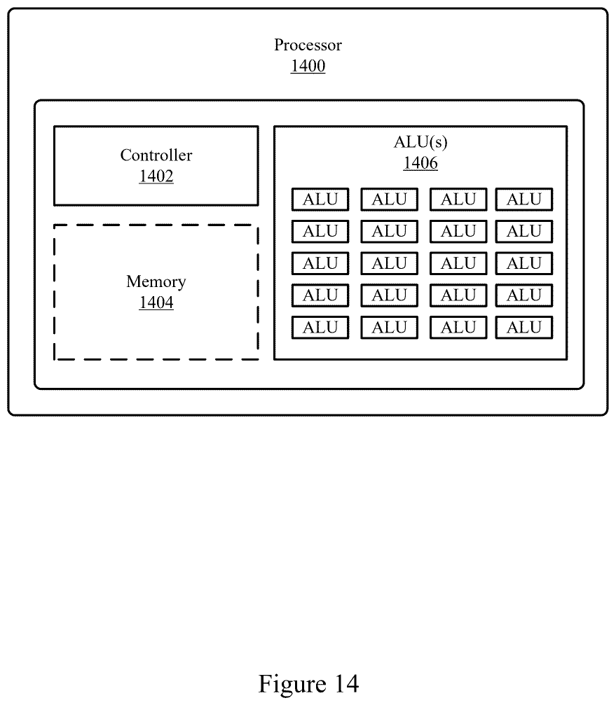

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to receive configuration information including one or more parameters associated with identifying a field of view; receive a reference signal based at least in part on a receive antenna configuration, where the receive antenna configuration is based at least in part on the configuration information; and perform at least one sensing measurement based at least in part on the reference signal.

Additionally, the processor 1400 may be configured to or operable to support any one or combination of where the configuration information includes an expected target field of view and uncertainty information associated with the expected target field of view; the configuration information indicates scan limit information including one or more of: at least one minimum scan limit, at least one maximum scan limit, at least one minimum beam sweep limit, at least one maximum beam sweep limit, or at least one beam sweep direction; the configuration information further includes field of view information elements, where the field of view information elements includes one or more of: an uptilt indication, a downtilt indication, an expected angular resolution, an expected angular uncertainty, an expected bistatic angular information, an expected beam power, or an expected beamwidth; the configuration information further includes LCS to GCS translation parameters including one or more of a bearing angle, a downtilt angle, or a slant angle.

Additionally, the processor 1400 may be configured to or operable to support any one or combination of where the configuration information further includes one or more scan mode indications, and each of the one or more scan mode indications is based at least in part on a respective type of scan mode; the configuration information includes one or more of field of view information, scan limit information, or scan mode information; the one or more of the field of view information, the scan limit information, or the scan mode information is associated with validity criteria; and the validity criteria includes one or more of a temporal validity criterion or an area validity criterion; the at least one controller is configured to cause the processor to one or more of: request one or more of updated field of view information, updated scan limit information, or updated scan mode information; or receive one or more of updated field of view information, updated scan limit information, or updated scan mode information; the at least one controller is configured to cause the processor to transmit a reference signal based at least in part on a transmit antenna configuration, where the transmit antenna configuration is based at least in part on the configuration information.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to transmit configuration information including one or more parameters associated with identifying a field of view, where the configuration information includes an expected target field of view and uncertainty information associated with the expected target field of view.

Additionally, the processor 1400 may be configured to or operable to support any one or combination of to transmit a reference signal based at least in part on a transmit antenna configuration, where the transmit antenna configuration is based at least in part on the configuration information; the NE includes a RAN entity or a CN entity.

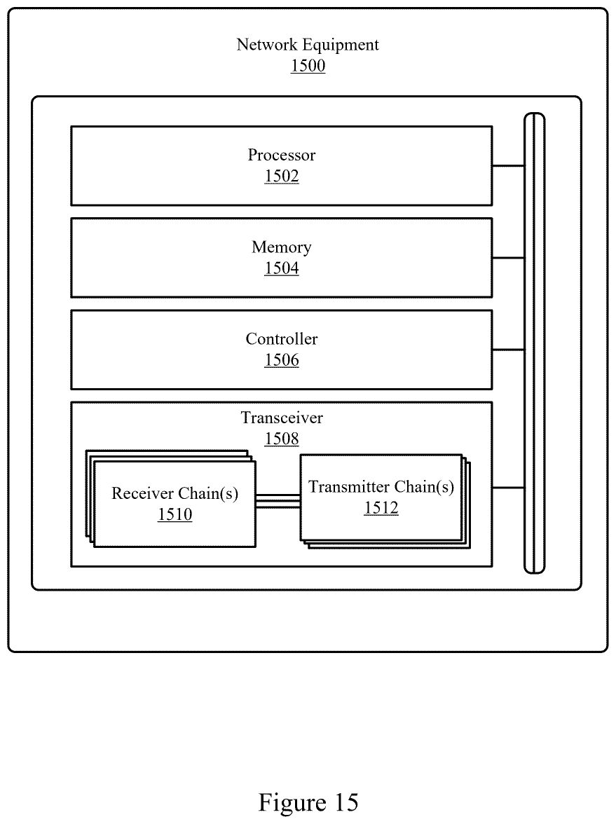

FIG. 15 illustrates an example of an NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504).

For example, the processor 1502 may support wireless communication at the NE 1500 in accordance with examples as disclosed herein. The NE 1500 may be configured to or operable to support a means for receiving configuration information including one or more parameters associated with identifying a field of view; receiving a reference signal based at least in part on a receive antenna configuration, where the receive antenna configuration is based at least in part on the configuration information; and performing at least one sensing measurement based at least in part on the reference signal.

Additionally, the NE 1500 may be configured to or operable to support any one or combination of where the configuration information includes an expected target field of view and uncertainty information associated with the expected target field of view; the configuration information indicates scan limit information including one or more of: at least one minimum scan limit, at least one maximum scan limit, at least one minimum beam sweep limit, at least one maximum beam sweep limit, or at least one beam sweep direction; the configuration information further includes field of view information elements, the field of view information elements include one or more of: an uptilt indication, a downtilt indication, an expected angular resolution, an expected angular uncertainty, an expected bistatic angular information, an expected beam power, or an expected beamwidth; the configuration information further includes LCS to GCS translation parameters including one or more of a bearing angle, a downtilt angle, or a slant angle; the configuration information further includes one or more scan mode indications, and where each of the one or more scan mode indications is based at least in part on a respective type of scan mode; the configuration information includes one or more of field of view information, scan limit information, or scan mode information; the one or more of the field of view information, the scan limit information, or the scan mode information is associated with validity criteria; and the validity criteria includes one or more of a temporal validity criterion or an area validity criterion; one or more of: requesting one or more of updated field of view information, updated scan limit information, or updated scan mode information; or receiving one or more of updated field of view information, updated scan limit information, or updated scan mode information.

Additionally, or alternatively, the NE 1500 may support at least one memory (e.g., the memory 1504) and at least one processor (e.g., the processor 1502) coupled with the at least one memory and configured to cause the NE to receive configuration information including one or more parameters associated with identifying a field of view; receive a reference signal based at least in part on a receive antenna configuration, where the receive antenna configuration is based at least in part on the configuration information; and perform at least one sensing measurement based at least in part on the reference signal.

Additionally, the NE 1500 may be configured to support any one or combination of where the configuration information includes an expected target field of view and uncertainty information associated with the expected target field of view; the configuration information indicates scan limit information including one or more of: at least one minimum scan limit, at least one maximum scan limit, at least one minimum beam sweep limit, at least one maximum beam sweep limit, or at least one beam sweep direction; the configuration information further includes field of view information elements, where the field of view information elements include one or more of: an uptilt indication, a downtilt indication, an expected angular resolution, an expected angular uncertainty, an expected bistatic angular information, an expected beam power, or an expected beamwidth; the configuration information further includes LCS to GCS translation parameters including one or more of a bearing angle, a downtilt angle, or a slant angle; the configuration information further includes one or more scan mode indications, and where each of the one or more scan mode indications is based at least in part on a respective type of scan mode; the configuration information includes one or more of field of view information, scan limit information, or scan mode information; the one or more of the field of view information, the scan limit information, or the scan mode information is associated with validity criteria; and the validity criteria includes one or more of a temporal validity criterion or an area validity criterion; the at least one processor is configured to cause the NE to one or more of: request one or more of updated field of view information, updated scan limit information, or updated scan mode information; or receive one or more of updated field of view information, updated scan limit information, or updated scan mode information.

For example, the processor 1502 may support wireless communication at the NE 1500 in accordance with examples as disclosed herein. The NE 1500 may be configured to or operable to support a means for transmitting configuration information including one or more parameters associated with identifying a field of view, where the configuration information includes an expected target field of view and uncertainty information associated with the expected target field of view.

Additionally, the NE 1500 may be configured to or operable to support any one or combination of transmitting a reference signal based at least in part on a transmit antenna configuration, where the transmit antenna configuration is based at least in part on the configuration information; the NE includes a RAN entity or a CN entity.

Additionally, or alternatively, the NE 1500 may support at least one memory (e.g., the memory 1504) and at least one processor (e.g., the processor 1502) coupled with the at least one memory and configured to cause the NE to transmit configuration information including one or more parameters associated with identifying a field of view, where the configuration information includes an expected target field of view and uncertainty information associated with the expected target field of view.

Additionally, the NE 1500 may be configured to support any one or combination of to transmit a reference signal based at least in part on a transmit antenna configuration, where the transmit antenna configuration is based at least in part on the configuration information; the NE includes a RAN entity or a CN entity.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

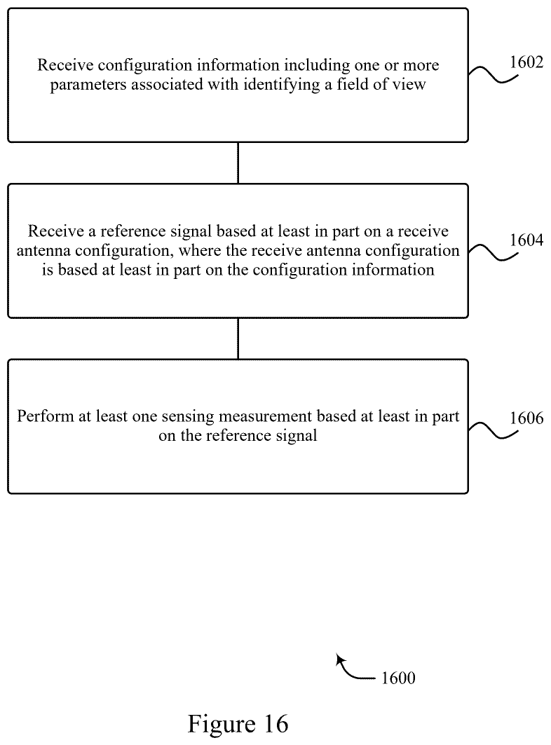

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1602, the method may include receiving configuration information including one or more parameters associated with identifying a field of view. The operations of 1602 may be performed in accordance with examples as described herein. In some implementations, aspects of the operations of 1602 may be performed by a UE as described with reference to FIG. 13.

At 1604, the method may include receiving a reference signal based at least in part on a receive antenna configuration, where the receive antenna configuration is based at least in part on the configuration information. The operations of 1604 may be performed in accordance with examples as described herein. In some implementations, aspects of the operations of 1604 may be performed by a UE as described with reference to FIG. 13.

At 1606, the method may include performing at least one sensing measurement based at least in part on the reference signal. The operations of 1606 may be performed in accordance with examples as described herein. In some implementations, aspects of the operations of 1606 may be performed a UE as described with reference to FIG. 13.

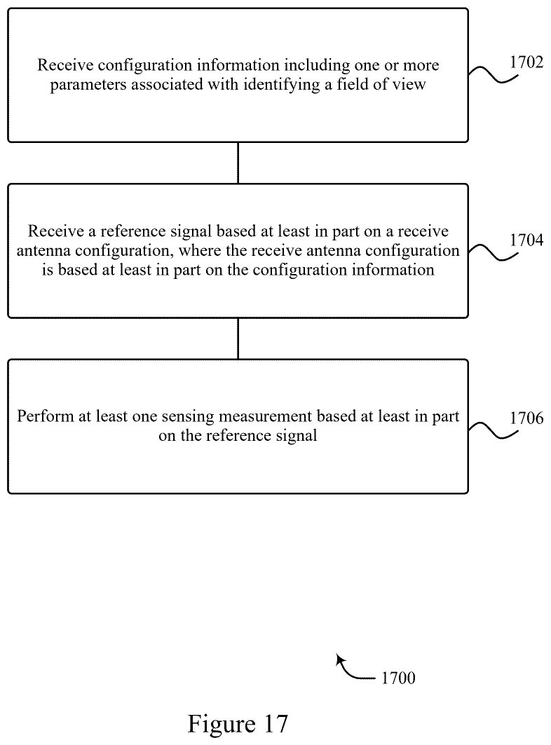

FIG. 17 illustrates a flowchart of a method 1700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include receiving configuration information including one or more parameters associated with identifying a field of view. The operations of 1702 may be performed in accordance with examples as described herein. In some implementations, aspects of the operations of 1702 may be performed by an NE as described with reference to FIG. 15.

At 1704, the method may include receiving a reference signal based at least in part on a receive antenna configuration, where the receive antenna configuration is based at least in part on the configuration information. The operations of 1704 may be performed in accordance with examples as described herein. In some implementations, aspects of the operations of 1704 may be performed by an NE as described with reference to FIG. 15.

At 1706, the method may include performing at least one sensing measurement based at least in part on the reference signal. The operations of 1706 may be performed in accordance with examples as described herein. In some implementations, aspects of the operations of 1706 may be performed an NE as described with reference to FIG. 15.

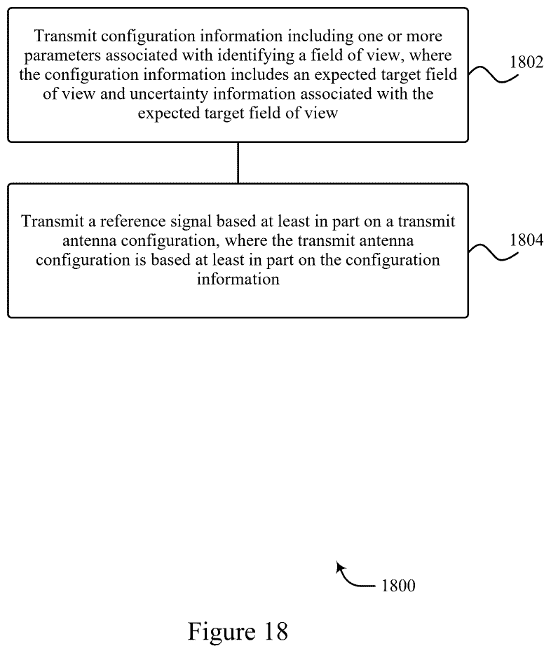

FIG. 18 illustrates a flowchart of a method 1800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1802, the method may include transmitting configuration information including one or more parameters associated with identifying a field of view, where the configuration information includes an expected target field of view and uncertainty information associated with the expected target field of view. The operations of 1802 may be performed in accordance with examples as described herein. In some implementations, aspects of the operations of 1802 may be performed by an NE as described with reference to FIG. 15.

At 1804, the method may include transmitting a reference signal based at least in part on a transmit antenna configuration, where the transmit antenna configuration is based at least in part on the configuration information. The operations of 1804 may be performed in accordance with examples as described herein. In some implementations, aspects of the operations of 1804 may be performed by an NE as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive configuration information including one or more parameters associated with identifying a field of view;
receive a reference signal based at least in part on a receive antenna configuration, wherein the receive antenna configuration is based at least in part on the configuration information; and
perform at least one sensing measurement based at least in part on the reference signal.

2. The UE of claim 1, wherein the configuration information comprises an expected target field of view and uncertainty information associated with the expected target field of view.

3. The UE of claim 1, wherein the configuration information indicates scan limit information comprising one or more of:
at least one minimum scan limit, at least one maximum scan limit, at least one minimum beam sweep limit, at least one maximum beam sweep limit, or at least one beam sweep direction.

4. The UE of claim 1, wherein the configuration information further comprises field of view information elements, wherein the field of view information elements comprises one or more of:
an uptilt indication, a downtilt indication, an expected angular resolution, an expected angular uncertainty, an expected bistatic angular information, an expected beam power, or an expected beamwidth.

5. The UE of claim 1, wherein the configuration information further comprises local coordinate system (LCS) to global coordinate system (GCS) translation parameters comprising one or more of a bearing angle, a downtilt angle, or a slant angle.

6. The UE of claim 1, wherein the configuration information further comprises one or more scan mode indications, and wherein each of the one or more scan mode indications is based at least in part on a respective type of scan mode.

7. The UE of claim 1, wherein:
the configuration information comprises one or more of field of view information, scan limit information, or scan mode information;
the one or more of the field of view information, the scan limit information, or the scan mode information is associated with validity criteria; and
the validity criteria comprises one or more of a temporal validity criterion or an area validity criterion.

8. The UE of claim 1, wherein the at least one processor is configured to cause the UE to one or more of:
request one or more of updated field of view information, updated scan limit information, or updated scan mode information; or
receive one or more of updated field of view information, updated scan limit information, or updated scan mode information.

9. A processor for wireless communication, comprising:
at least one controller coupled with at least one memory and configured to cause the processor to:
receive configuration information including one or more parameters associated with identifying a field of view;
receive a reference signal based at least in part on a receive antenna configuration, wherein the receive antenna configuration is based at least in part on the configuration information; and
perform at least one sensing measurement based at least in part on the reference signal.

10. A network equipment (NE) for wireless communication, comprising:
at least one memory; and
at least one processor coupled with the at least one memory and configured to cause the NE to:
receive configuration information including one or more parameters associated with identifying a field of view;
receive a reference signal based at least in part on a receive antenna configuration, wherein the receive antenna configuration is based at least in part on the configuration information; and
perform at least one sensing measurement based at least in part on the reference signal.

11. The NE of claim 10, wherein the configuration information comprises an expected target field of view and uncertainty information associated with the expected target field of view.

12. The NE of claim 10, wherein the configuration information indicates scan limit information comprising one or more of:
at least one minimum scan limit, at least one maximum scan limit, at least one minimum beam sweep limit, at least one maximum beam sweep limit, or at least one beam sweep direction.

13. The NE of claim 10, wherein the configuration information further comprises field of view information elements, wherein the field of view information elements comprise one or more of:
an uptilt indication, a downtilt indication, an expected angular resolution, an expected angular uncertainty, an expected bistatic angular information, an expected beam power, or an expected beamwidth.

14. The NE of claim 10, wherein the configuration information further comprises local coordinate system (LCS) to global coordinate system (GCS) translation parameters comprising one or more of a bearing angle, a downtilt angle, or a slant angle.

15. The NE of claim 10, wherein the configuration information further comprises one or more scan mode indications, and wherein each of the one or more scan mode indications is based at least in part on a respective type of scan mode.

16. The NE of claim 10, wherein:
the configuration information comprises one or more of field of view information, scan limit information, or scan mode information;
the one or more of the field of view information, the scan limit information, or the scan mode information is associated with validity criteria; and
the validity criteria comprises one or more of a temporal validity criterion or an area validity criterion.

17. The NE of claim 10, wherein the at least one processor is configured to cause the NE to one or more of:
request one or more of updated field of view information, updated scan limit information, or updated scan mode information; or
receive one or more of updated field of view information, updated scan limit information, or updated scan mode information.

18. A network equipment (NE) for wireless communication, comprising:
at least one memory; and
at least one processor coupled with the at least one memory and configured to cause the NE to:
transmit configuration information including one or more parameters associated with identifying a field of view, wherein the configuration information comprises an expected target field of view and uncertainty information associated with the expected target field of view.

19. The NE of claim 18, wherein the at least one processor is configured to cause the NE to:
transmit a reference signal based at least in part on a transmit antenna configuration, wherein the transmit antenna configuration is based at least in part on the configuration information.

20. The NE of claim 18, wherein the NE comprises a radio access network (RAN) entity or a core network (CN) entity.
